(19) United States
(12) Patent Application Publication
(10) Pub. No.: US 2023/0231456 A1
(43) Pub. Date: Jul. 20, 2023

(54) ELECTRIC MOTOR, DRIVING DEVICE, COMPRESSOR, AND AIR CONDITIONER

(71) Applicant: Mitsubishi Electric Corporation, Tokyo (JP)

(72) Inventors: Tomoki MASUKO, Tokyo (JP); Atsushi MATSUOKA, Tokyo (JP)

(21) Appl. No.: 18/001,766

(22) PCT Filed: Aug. 13, 2020
(86) PCT No.: PCT/JP2020/030751

§ 371 Date: Dec. 14, 2022

(51) Int. Cl. H02K 21/14; H02K 3/18; H02K 3/28

(52) U.S. Cl. CPC H02K 21/14; H02K 3/18; H02K 3/28; F04D 25/06

(57) ABSTRACT

An electric motor includes a rotor, a stator, and a connection switching unit. The stator includes a stator core including 6×n (n is an integer equal to or larger than 1) slots, and three-phase coils forming 2×n magnetic poles. The connection switching unit switches a connection state of the three-phase coils between a first connection state and a second connection state. The three-phase coils include 2×n U-phase coils, 2×n V-phase coils, and 2×n W-phase coils in a coil end. Each coil of the three-phase coils is disposed in two slots across one slot on one end side of the stator core.

### CROSS-REFERENCE TO RELATED APPLICATION

This application is a U.S. National Stage Application of International Application No. PCT/JP2020/030751 filed on Aug. 13, 2020, the contents of which are incorporated herein by reference.

### TECHNICAL FIELD

The present disclosure relates to an electric motor.

### BACKGROUND

An electric motor including three-phase coils attached to a stator core by distributed winding is generally used (see, for example, Patent Literature 1). In an electric motor including three-phase coils, in a case where the number of turns of a winding (also referred to as a stator winding) forming three-phase coils is large, the electric motor can be driven with a small current (also referred to as an electric motor current), and an inverter loss can be reduced. As a result, efficiency of the electric motor (also referred to as motor efficiency) can be enhanced. In the case where the number of turns of the winding is large, however, an induced voltage in the three-phase coils increases, and thus a rotation speed of the electric motor cannot be increased in some cases. On the other hand, in a case where the number of turns of the winding is small, an induced voltage in the three-phase coils can be reduced, and thus the rotation speed of the electric motor can be increased.

### PATENT REFERENCE

Patent Reference 1: Japanese Patent Application Publication No. H09-154266

With a conventional technique, however, when the rotation speed of an electric motor is increased, a circulating current is generated in three-phase coils due to a third harmonic component of an induced voltage depending on a connection state of the three-phase coils, and thus performance of the electric motor might degrade. Consequently, efficiency of the electric motor decreases disadvantageously.

### SUMMARY

It is therefore an object of the present disclosure to enhance efficiency of an electric motor.

An electric motor according to an aspect of the present disclosure includes: a stator including a stator core including 6×n (n is an integer equal to or larger than 1) slots and three-phase coils attached to the stator core by distributed winding, the three-phase coils forming 2×n magnetic poles; a rotor including a permanent magnet and disposed inside the stator; and a connection switching unit to switch a connection state of the three-phase coils between a first connection state and a second connection state that is different from the first connection state, wherein the three-phase coils include 2×n U-phase coils, 2×n V-phase coils, and 2×n W-phase coils in a coil end of the three-phase coils, and each coil of the three-phase coils is disposed in two slots of the 6×n slots across one slot on one end side of the stator core.

An electric motor according to another aspect of the present disclosure includes: a stator including a stator core including 9×n (n is an integer equal to or larger than 1) slots and three-phase coils attached to the stator core by distributed winding, the three-phase coils forming 4×n magnetic poles; a rotor including a permanent magnet and disposed inside the stator; and a connection switching unit to switch a connection state of the three-phase coils between a first connection state and a second connection state that is different from the first connection state, wherein the three-phase coils include 3×n U-phase coils, 3×n V-phase coils, and 3×n W-phase coils in a coil end of the three-phase coils, each coil of the three-phase coils is disposed in two slots of the 9×n slots across one slot on one end side of the stator core, and the number of slots per pole per phase is 3.

A driving device according to yet another aspect of the present disclosure includes: the electric motor; and a control device to control the connection switching unit.

A compressor according to still another aspect of the present disclosure includes: a closed container; and a compression device disposed in the closed container; and the electric motor to drive the compression device.

An air conditioner according to still another aspect of the present disclosure includes: the compressor; and a heat exchanger.

According to the present disclosure, efficiency of an electric motor can be enhanced.

### BRIEF DESCRIPTION OF THE DRAWINGS

FIG. 1 is a top view schematically illustrating a structure of an electric motor according to a first embodiment.

FIG. 2 is a cross-sectional view schematically illustrating a structure of a rotor.

FIG. 3 is a top view schematically illustrating a structure of a stator.

FIG. 4 is a diagram illustrating arrangement of three-phase coils in slots.

FIG. 5 is a diagram schematically illustrating arrangement of three-phase coils in a coil end and arrangement of three-phase coils in the slots.

FIG. 6 is a diagram illustrating an example of coils connected in series in each phase.

FIG. 7 is a diagram illustrating an example of coils connected in parallel in each phase.

FIG. 8 is a diagram illustrating an example of an inserter for inserting three-phase coils in a stator core.

FIG. 9 is a diagram illustrating an example of a process of inserting the three-phase coils in the stator core.

FIG. 10 is a diagram illustrating an example of the process of inserting the three-phase coils in the stator core.

FIG. 11 is a block diagram illustrating a configuration of a driving device.

FIG. 12 is a block diagram illustrating a configuration of the driving device.

FIG. 13 is a diagram schematically illustrating three-phase coils connected by Y connection.

FIG. 14 is a diagram schematically illustrating three-phase coils connected by delta connection.

FIG. 15 is a graph showing a relationship between a line voltage and a rotation speed in the electric motor.

FIG. 16 is a graph showing a relationship between a line voltage and a rotation speed in the electric motor.

FIG. 17 is a graph showing a relationship between a torque and a rotation speed in the electric motor.

FIG. 18 is a graph showing a relationship between motor efficiency and a rotation speed.

FIG. 19 is a graph showing a relationship between motor efficiency and a rotation speed.

FIG. 20 is a top view illustrating an electric motor according to a comparative example.

FIG. 21 is a diagram schematically illustrating arrangement of three-phase coils and arrangement of three-phase coils in the slots in a coil end of the electric motor according to the comparative example.

FIG. 22 is a top view schematically illustrating a structure of an electric motor according to a third embodiment.

FIG. 23 is a cross-sectional view schematically illustrating a structure of a rotor of the electric motor illustrated in FIG. 22.

FIG. 24 is a top view schematically illustrating a structure of a stator of the electric motor illustrated in FIG. 22.

FIG. 25 is a diagram illustrating arrangement of three-phase coils in slots of the stator illustrated in FIG. 24.

FIG. 26 is a diagram schematically illustrating arrangement of three-phase coils and arrangement of three-phase coils in slots in a coil end of the stator illustrated in FIG. 24.

FIG. 27 is a top view schematically illustrating a structure of an electric motor according to a fourth embodiment.

FIG. 28 is a diagram schematically illustrating arrangement of three-phase coils and arrangement of three-phase coils in slots in a coil end of a stator of the electric motor illustrated in FIG. 27.

FIG. 29 is a cross-sectional view schematically illustrating a structure of a compressor according to a fifth embodiment.

FIG. 30 is a diagram schematically illustrating a configuration of a refrigeration air conditioning apparatus according to a sixth embodiment.

### DETAILED DESCRIPTION

### First Embodiment

In an xyz orthogonal coordinate system shown in each drawing, a z-axis direction (z axis) represents a direction parallel to an axis Ax of an electric motor 1, an x-axis direction (x axis) represents a direction orthogonal to the z-axis direction (z axis), and a y-axis direction (y axis) represents a direction orthogonal to both the z-axis direction and the x-axis direction. The axis Ax is the center of a stator 3, and is the rotation center of a rotor 2. A direction parallel to the axis Ax is also referred to as an “axial direction of the rotor 2” or simply as an “axial direction.” The radial direction refers to a radial direction of the rotor 2 or the stator 3, and is a direction orthogonal to the axis Ax. An xy plane is a plane orthogonal to the axial direction. An arrow D1 represents a circumferential direction about the axis Ax. The circumferential direction of the rotor 2 or the stator 3 will be also referred to simply as a “circumferential direction.”

### <Electric Motor 1>

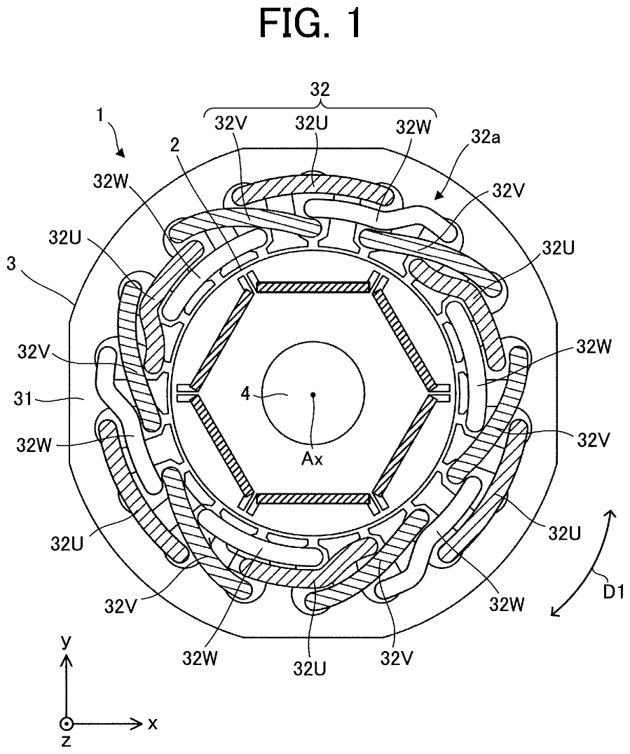

FIG. 1 is a top view schematically illustrating a structure of the electric motor 1 according to a first embodiment.

The electric motor 1 includes the rotor 2 having a plurality of magnetic poles, the stator 3, and a shaft 4 fixed to the rotor 2. The electric motor 1 is, for example, a permanent magnet synchronous motor.

The rotor 2 is rotatably disposed at the inner side of the stator 3. An air gap is present between the rotor 2 and the stator 3. The rotor 2 rotates about the axis Ax.

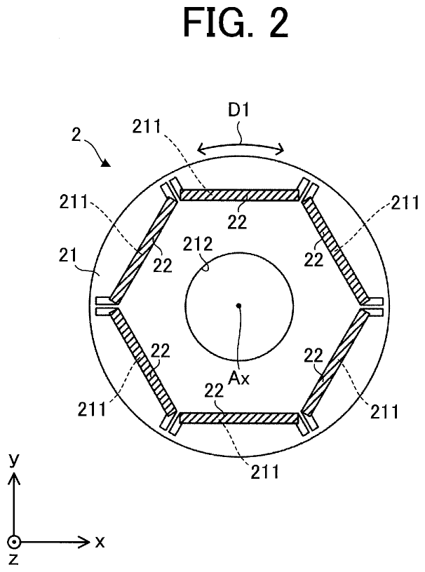

FIG. 2 is a cross-sectional view schematically illustrating a structure of the rotor 2.

The rotor 2 includes a rotor core 21 and at least one permanent magnet 22. The rotor 2 includes 2×n (n is an integer equal to or larger than 1) magnetic poles.

The rotor core 21 includes a plurality of magnet insertion holes 211, and a shaft hole 212 in which the shaft 4 is disposed. The rotor core 21 may further include at least one flux barrier portion that is a space communicating with each of the magnet insertion holes 211.

In this embodiment, the rotor 2 includes a plurality of permanent magnets 22. Each of the permanent magnets 22 is disposed in a corresponding one of the magnet insertion holes 211.

One permanent magnet 22 forms one magnetic pole, that is, a north pole or a south pole, of the rotor 2. It should be noted that two or more permanent magnets 22 may form one magnetic pole of the rotor 2.

In this embodiment, in the xy plane, one permanent magnet 22 forming one magnetic pole of the rotor 2 is oriented straight. Alternatively, in the xy plane, a pair of permanent magnets 22 forming one magnetic pole of the rotor 2 may be disposed to have a V shape.

The center of each magnetic pole of the rotor 2 is located at the center of each magnetic pole of the rotor 2 (i.e., a north pole or a south pole of the rotor 2). Each magnetic pole of the rotor 2 (hereinafter simply referred to as “each magnetic pole” or a “magnetic pole”) refers to a region serving as a north pole or a south pole of the rotor 2.

### <Stator 3>

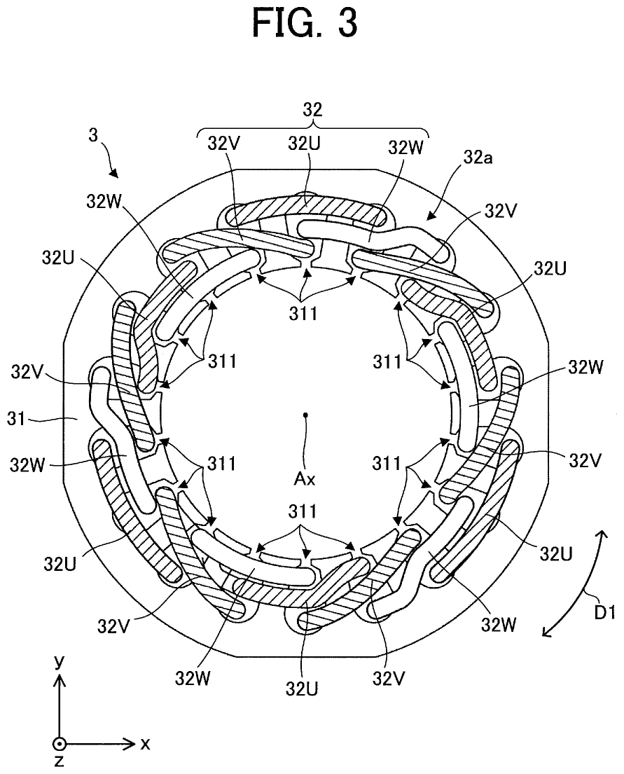

FIG. 3 is a top view schematically illustrating a structure of the stator 3.

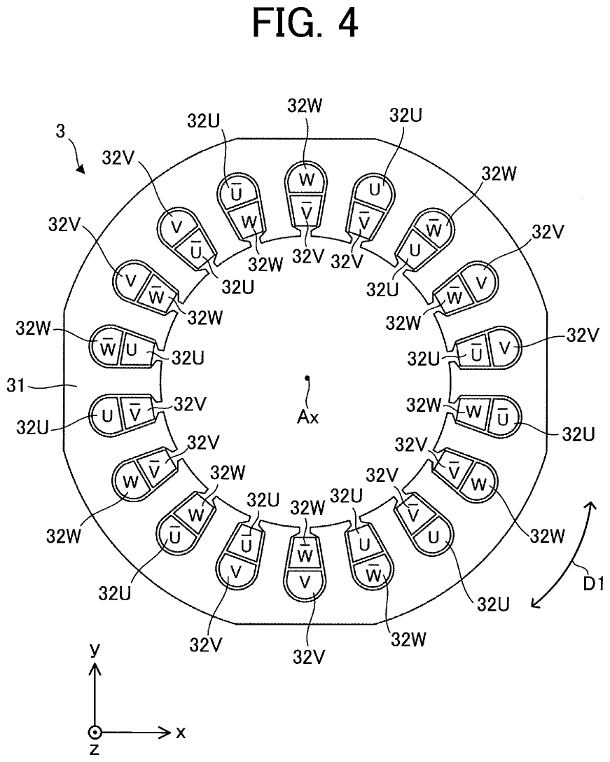

FIG. 4 is a diagram illustrating arrangement of three-phase coils 32 in slots 311.

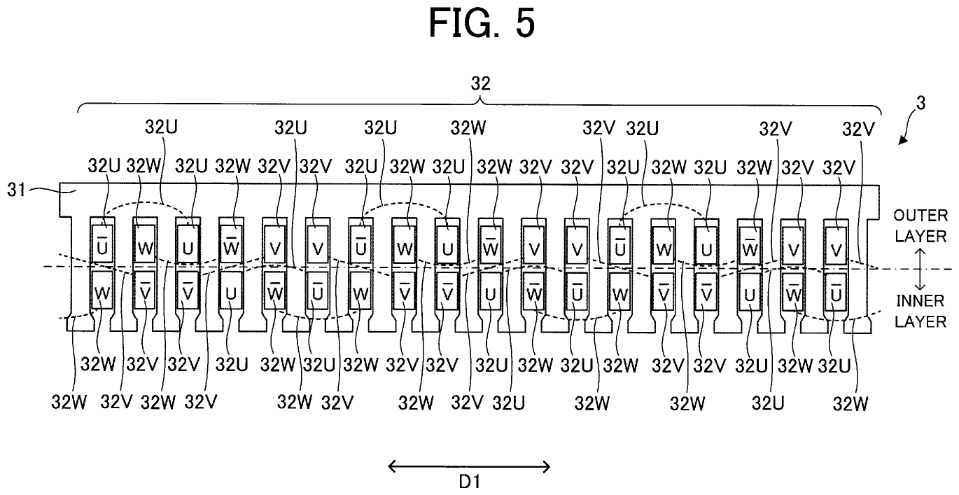

FIG. 5 is a diagram schematically illustrating arrangement of the three-phase coils 32 in a coil end 32a and arrangement of the three-phase coils 32 in the slots 311. In FIG. 5, broken lines indicate coils of each phase in the coil end 32a, and a chain line indicates a boundary between inner layers and outer layers in the slots 311.

As illustrated in FIG. 3, the stator 3 includes a stator core 31 and the three-phase coils 32 attached to the stator core 31 by distributed winding.

The stator core 31 includes an annular yoke, a plurality of teeth extending from the yoke in the radial direction, and 6×n (n is an integer equal to or larger than 1) slots 311 in which the three-phase coils 32 are disposed. The slots 311 will also be referred to as a first slot, a second slot, . . . , and an N-th slot, for example. As illustrated in FIGS. 4 and 5, each of the 6×n slots 311 includes an inner layer in which one of the three-phase coils 32 is disposed and an outer layer which is located outside the inner layer in the radial direction and in which one of the three-phase coils 32 is disposed. That is, in the example illustrated in FIGS. 4 and 5, space in each slot 311 is divided into the inner layer and the outer layer. In this embodiment, n=3. Thus, in the example illustrated in FIGS. 3 through 5, the stator core 31 includes 18 slots 311.

The three-phase coils 32 (i.e., coils of the individual phases) have coil sides disposed in the slots 311 and the coil ends 32a not disposed in the slots 311. Each of the coil ends 32a is an end portion of the three-phase coils 32 in the axial direction.

The three-phase coils 32 include 2×n U-phase coils 32U, 2×n V-phase coils 32V, and 2×n W-phase coils 32W in each coil end 32a. In other words, the three-phase coils 32 include 2×n U-phase coils 32U, 2×n V-phase coils 32V, and 2×n W-phase coils 32W on the stator core 31. That is, the three-phase coils 32 have three phases of a first phase, a second phase, and a third phase. For example, the first phase is a U phase, the second phase is a V phase, and the third phase is a W phase. In this embodiment, the three phases will be referred to as the U phase, the V phase, and the W phase, respectively. The U-phase coils 32U, the V-phase coils 32V, and the W-phase coils 32W illustrated in FIGS. 1 and 3 will also be referred to simply as coils.

In this embodiment, n=3. Thus, in the example illustrated in FIGS. 1 and 3, in each coil end 32a, the three-phase coils 32 include six U-phase coils 32U, six V-phase coils 32V, and six W-phase coils 32W. The number of coils of each phase is not limited to six. In this embodiment, the stator 3 has the structure illustrated in FIG. 3 in two coil ends 32a. The stator 3 only needs to have the structure illustrated in FIG. 3 in one of the two coil ends 32a.

When a current flows through the three-phase coils 32, the three-phase coils 32 form 2×n magnetic poles. In this embodiment, n=3. Thus, in this embodiment, when a current flows through the three-phase coils 32, the three-phase coils 32 form six magnetic poles.

As illustrated in FIGS. 1 and 3, the coils of the three-phase coils 32 are disposed in the slots 311 at a two-slot pitch on one end side of the stator core 31. The two-slot pitch means “each two slots.” That is, the two-slot pitch means that one coil is disposed for each two slots in the slots 311. In other words, the two-slot pitch means that one coil is disposed across one slot in the slots 311. Thus, as illustrated in FIGS. 1 and 3, each coil of the three-phase coils 32 is disposed in the two slots 311 across one slot on one end side of the stator core 31. In other words, each coil of the three-phase coils 32 is disposed in two slots 311 with one slot 311 interposed therebetween on one end side of the stator core 31.

As illustrated in FIGS. 4 and 5, two coils are disposed in each of the slots 311. Each coil is disposed in the slot 311 together with a coil of another phase. That is, two coils of different phases are disposed in each slot 311. The coils of each phase are disposed in six inner layers and in six outer layers.

### <Arrangement of U-Phase Coils 32U in Slots 311>

Arrangement of the U-phase coils 32U in the slots 311 will be specifically described.

In the 2×n U-phase coils 32U, n U-phase coils 32U are disposed in the outer layers of the slots 311. In the 2×n U-phase coils 32U, other n U-phase coils 32U are disposed in the inner layers of the slots 311. In the example illustrated in FIG. 1, three U-phase coils 32U are disposed in the outer layers of the slots 311, and other three U-phase coils 32U are disposed in the inner layers of the slots 311.

### <Arrangement of V-Phase Coils 32V in Slots 311>

Arrangement of the V-phase coils 32V in the slots 311 will be specifically described.

Some of the V-phase coils 32V are disposed in the inner layers of the slots 311 in which the U-phase coils 32U are disposed. Others of the V-phase coils 32V are disposed in the outer layers of the slots 311 in which the W-phase coils 32W are disposed. That is, in the case where some of the V-phase coils 32V are disposed in the outer layers of the slots 311 in which coils of another phase are disposed, others of the V-phase coils 32V are disposed in the inner layers of the slots 311 in which coils of another phase are disposed. In the case where some of the V-phase coils 32V are disposed in the inner layers of the slots 311 in which coils of another phase are disposed, others of the V-phase coils 32V are disposed in the outer layers of the slots 311 in which coils of another phase are disposed.

### <Arrangement of W-Phase Coils 32W in Slots 311>

Arrangement of the W-phase coils 32W in the slots 311 will be specifically described.

In the 2×n W-phase coils 32W, n W-phase coils 32W are disposed in the outer layers of the slots 311. In the 2×n W-phase coils 32W, other n W-phase coils 32W are disposed in the inner layers of the slots 311. In the example illustrated in FIG. 1, three W-phase coils 32W are disposed in the outer layers of the slots 311, and other three W-phase coils 32W are disposed in the inner layers of the slots 311.

<Arrangement of Three-Phase Coils 32 in Coil End 32a>

The n U-phase coils 32U disposed in the outer layers of the slots 311 are arranged at regular intervals in the circumferential direction. The n U-phase coils 32U disposed in the inner layers of the slots 311 are arranged at regular intervals in the circumferential direction. The 2×n V-phase coils 32V are arranged at regular intervals in the circumferential direction. The n W-phase coils 32W disposed in the outer layers of the slots 311 are arranged at regular intervals in the circumferential direction. The n W-phase coils 32W disposed in the inner layers of the slots 311 are arranged at regular intervals in the circumferential direction.

### <Winding Factor of Fundamental Wave>

In the electric motor 1 according to this embodiment, three slots 311 correspond to one magnetic pole of the rotor 2, and the coils are arranged in the slots 311 at a two-slot pitch. Thus, a short-pitch factor kp of a fundamental wave of each coil is obtained by the following equation:

kp=sin{P/(Q/S)}×(π/2)

The short-pitch factor of the three-phase coils 32 by distributed winding is a factor representing a proportion of the amount of magnetic flux with which one coil can interlink. In this embodiment, P=6, Q=18, and S=2 are established, where P is the number of magnetic poles of the three-phase coils 32, Q is the number of slots 311, and S is a slot pitch number. Thus, kp=sin{(6/9)×(π/2)}=0.866.

A distributed winding factor kd of the three-phase coils 32 by distributed winding is a factor for correcting a phase difference of magnetic flux that interlink with the three-phase coils 32. Supposing the number of slots per pole per phase is q, a distributed winding factor kd of a fundamental wave is obtained by the following equation:

kd={sin(π/6)}/[q×sin{(π/6)/q}]

In this embodiment, q=1. Thus, kd=1.

Accordingly, in this embodiment, a winding factor kw of a fundamental wave of the electric motor 1 is obtained by the following equation:

kw=kp×kd=0.866×1=0.866

### <Third Winding Factor>

In the electric motor 1 according to this embodiment, three slots 311 correspond to one magnetic pole of the rotor 2, and the coils are arranged in the slots 311 at a two-slot pitch. Thus, a third short-pitch factor kp3 of each coil is obtained by the following equation:

kp3=sin{3×P/(Q/S)}×(π/2)

In this embodiment, P=6, Q=18, and S=2 are established, where P is the number of magnetic poles of the three-phase coils 32, Q is the number of slots 311, and S is a slot pitch number. Thus, kp3=sin{(3×6/9)×(π/2)}=0.

Supposing the number of slots per pole per phase is q, a third distributed winding factor kd is obtained by the following equation:

kd3={sin(3×π/6)}/[q×sin{(3×π/6)/q}]

In this embodiment, q=1. Thus, kd3=1.

Accordingly, in this embodiment, a third winding factor kw3 of the electric motor 1 is obtained by the following equation:

kw3=kp3×kd3=0×1=0

In a case where three-phase coils of an electric motor are connected by delta connection (also referred to as Δ connection), a circulating current is generated in the three-phase coils, and performance of the electric motor might degrade. In general, a circulating current arises from a third harmonic component included in an induced voltage occurring in the coils of each phase. In this embodiment, since the stator 3 has the arrangement of the three-phase coils 32 described above, no third harmonic component is included in an induced voltage occurring in the coils of each phase.

### <Coil Connection in Each Phase>

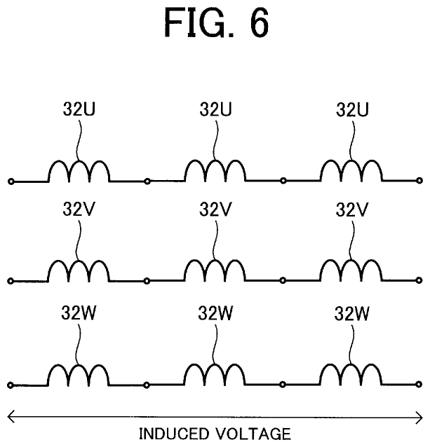

FIG. 6 is a diagram illustrating an example of coils connected in series in each phase.

In each phase, coils of the stator 3 are connected in series, for example. In the example illustrated in FIG. 6, three U-phase coils 32U are connected in series, three V-phase coils 32V are connected in series, and three W-phase coils 32W are connected in series.

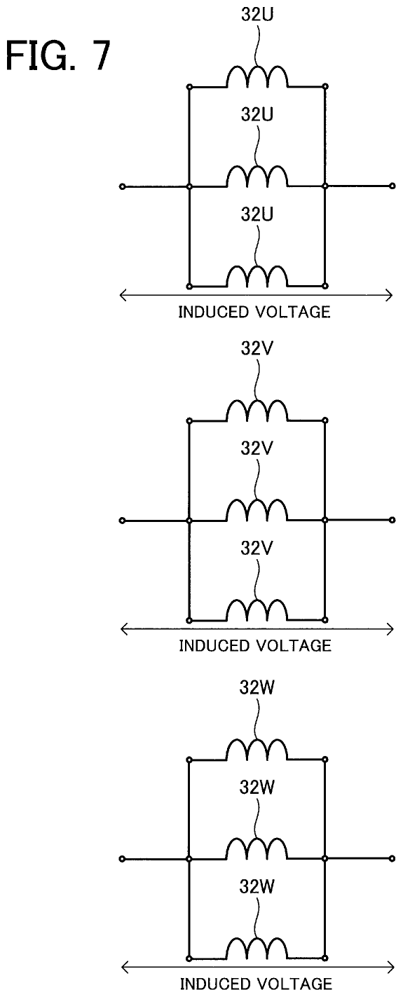

FIG. 7 is a diagram illustrating an example of coils connected in parallel in each phase.

In each phase, coils of the stator 3 are connected in parallel, for example. In the example illustrated in FIG. 7, three U-phase coils 32U are connected in parallel, three V-phase coils 32V are connected in parallel, and three W-phase coils 32W are connected in parallel.

### <Insulating Member>

The stator 3 may include an insulating member that insulates coils of each phase in the three-phase coils 32. The insulating member is, for example, insulating paper.

### <Inserter>

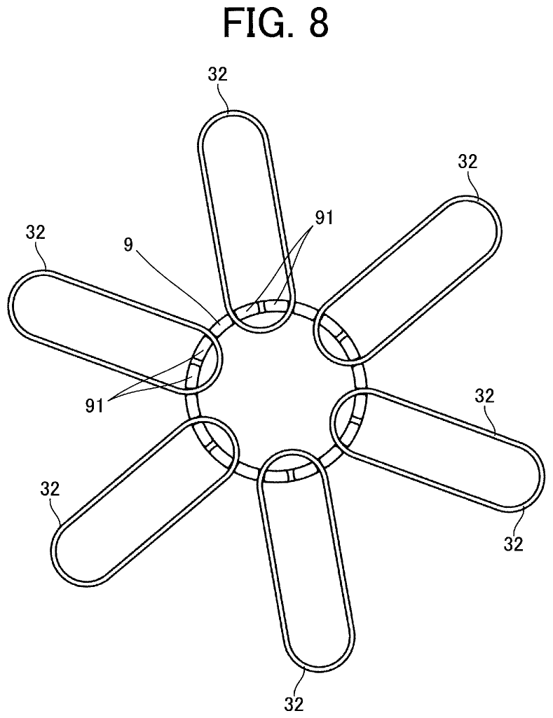

FIG. 8 is a diagram illustrating an example of an inserter 9 for inserting the three-phase coils 32 in the stator core 31.

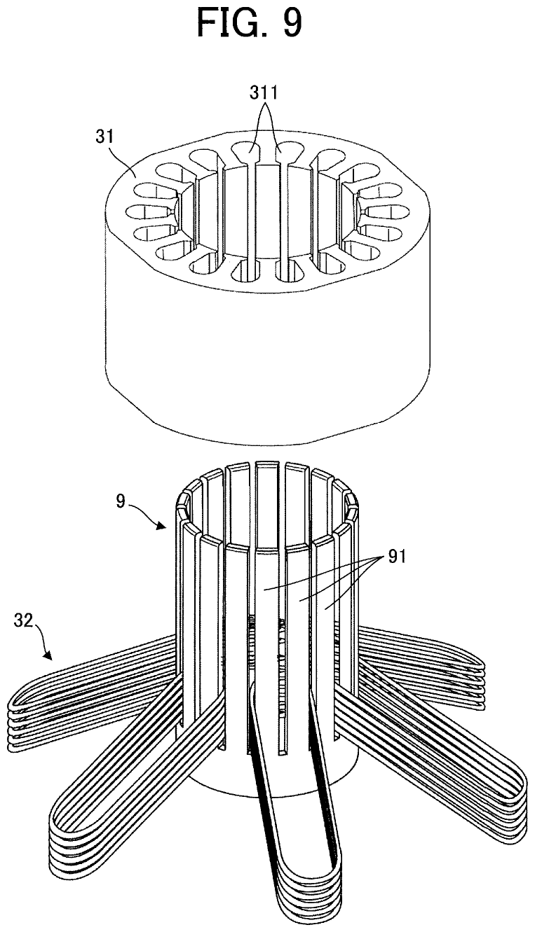

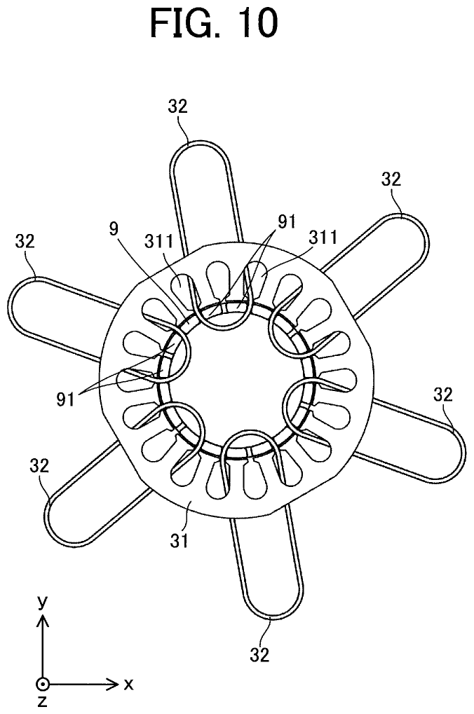

FIGS. 9 and 10 are diagrams showing an example of the process of inserting three-phase coils in the stator core 31.

The three-phase coils 32 are attached to the previously prepared stator core 31 by the inserter 9, for example. In this embodiment, the three-phase coils 32 are attached to the stator core 31 by distributed winding. In the case of inserting the three-phase coils 32 in the stator core 31 by the inserter 9 illustrated in FIG. 8, as illustrated in FIGS. 9 and 10, the three-phase coils 32 are disposed between blades 91 of the inserter 9, and the blades 91 are inserted in the inside of the stator core 31 together with the three-phase coils 32. Next, the three-phase coils 32 are slid in the axial direction to be disposed in the slots 311.

### <Configuration of Driving Device 100>

Next, a driving device 100 for driving the electric motor 1 will be described. The driving device 100 is mounted on an air conditioner (e.g., a refrigeration air conditioning apparatus 7 described in a sixth embodiment), for example. In this case, the electric motor 1 is mounted on the air conditioner and used as a driving source of an air conditioner.

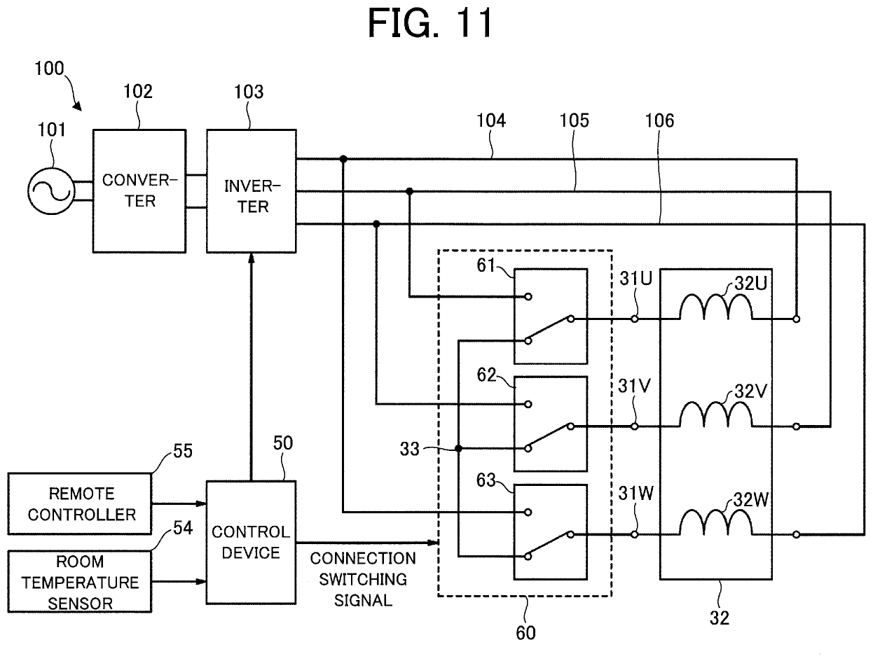

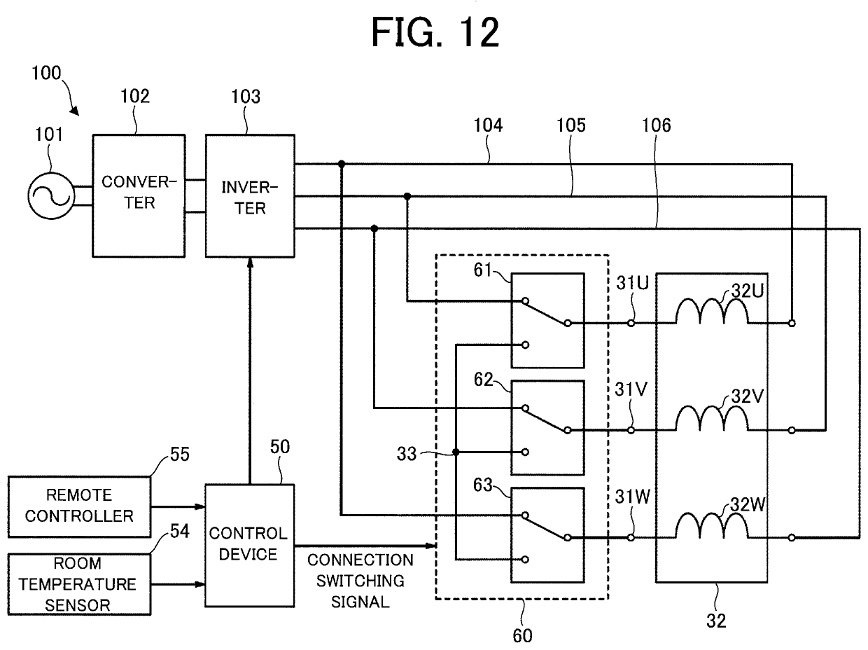

FIGS. 11 and 12 are block diagrams illustrating a configuration of the driving device 100. Connection states of the three-phase coils 32 are different between FIGS. 11 and 12.

The driving device 100 includes a converter 102 for rectifying an output of a power supply 101, an inverter 103 for applying a voltage (specifically an alternating current voltage) to the three-phase coils 32 of the electric motor 1, a connection switching unit 60 for switching a connection state of the three-phase coils 32 between a first connection state and a second connection state, and a control device 50. The connection switching unit 60 will also be referred to as a connection switch. The converter 102 is supplied with electric power from the power supply 101 as an alternating current (AC) power supply.

The first connection state is, for example, Y connection (also referred to as star connection). The second connection state is different from the first connection state. In the case where the first connection state is Y connection, the second connection state is delta connection. In this embodiment, the connection switching unit 60 switches the connection state of the three-phase coils 32 between Y connection and delta connection.

The electric motor 1 may include a driving device 100. The electric motor 1 may include some of components of the driving device 100. For example, the electric motor 1 may include the connection switching unit 60, or may include both the connection switching unit 60 and the control device 50.

The power supply 101 is an AC power supply of, for example, 200 V (effective voltage). The converter 102 is a rectifier circuit, and outputs a direct current (DC) voltage of 280 V, for example. A voltage output from the converter 102 will be referred to as a bus voltage. The inverter 103 is supplied with a bus voltage from the converter 102 and outputs a line voltage (also referred to as an electric motor voltage) to the three-phase coils 32 of the electric motor 1. The inverter 103 is connected to wires 104, 105, and 106 respectively connected to the U-phase coils 32U, the V-phase coils 32V, and the W-phase coils 32W.

The U-phase coils 32U have a terminal 31U. The V-phase coils 32V have a terminal 31V. The W-phase coils 32W have a terminal 31W.

The connection switching unit 60 includes a switch 61 (also referred to as a U-phase switch), a switch 62 (also referred to as a V-phase switch), and a switch 63 (also referred to as a W-phase switch). The switch 61 connects the terminal 31U of the U-phase coils 32U to the wire 105 or a neutral point 33. The switch 62 connects the terminal 31V of the V-phase coils 32V to the wire 106 or the neutral point 33. The switch 63 connects the terminal 31W of the W-phase coils 32W to the wire 104 or the neutral point 33. In the example illustrated in FIG. 11, the switches 61, 62, and 63 are relay contacts. Alternatively, the switches 61, 62, and 63 may be semiconductor switches.

The wire 104 is electrically connected to the U-phase coils 32U and the switch 63. The wire 105 is electrically connected to the V-phase coils 32V and the switch 61. The wire 106 is electrically connected to the W-phase coils 32W and the switch 62.

The control device 50 controls the inverter 103 and the connection switching unit 60. The control device 50 may control the converter 102. An operation instruction signal for operating an air conditioner from a remote controller 55 and a room temperature detected by a room temperature sensor 54 are input to the control device 50. For example, based on the input information, the control device 50 outputs a voltage switching signal to the converter 102, outputs an inverter driving signal to the inverter 103, and outputs a connection switching signal to the connection switching unit 60. When the connection switching unit 60 switches the connection state of the three-phase coils 32, the control device 50 controls the inverter 103 such that rotation of the electric motor 1 temporarily stops before switching is completed.

In the state illustrated in FIG. 11, the connection switching unit 60 sets the connection state of the three-phase coils 32 at Y connection. In this case, the switch 61 connects the terminal 31U of the U-phase coils 32U to the neutral point 33, the switch 62 connects the terminal 31V of the V-phase coils 32V to the neutral point 33, and the switch 63 connects the terminal 31W of the W-phase coils 32W to the neutral point 33. As a result, the connection state of the three-phase coils 32 illustrated in FIG. 11 is Y connection.

In FIG. 12, the switches 61, 62, and 63 of the connection switching unit 60 have been switched to the state illustrated in FIG. 12 from the state of the switches 61, 62, and 63 of the connection switching unit 60 illustrated in FIG. 11. In the state illustrated in FIG. 12, the connection switching unit 60 sets the connection state of the three-phase coils 32 at delta connection. In this case, the switch 61 connects the terminal 31U of the U-phase coils 32U to the wire 105, the switch 62 connects the terminal 31V of the V-phase coils 32V to the wire 106, and the switch 63 connects the terminal 31W of the W-phase coils 32W to the wire 104. As a result, the connection state of the three-phase coils 32 illustrated in FIG. 12 is delta connection.

As illustrated in FIGS. 11 and 12, the connection switching unit 60 can switch the connection state of the three-phase coils 32 between Y connection and delta connection by switching of the switches 61, 62, and 63.

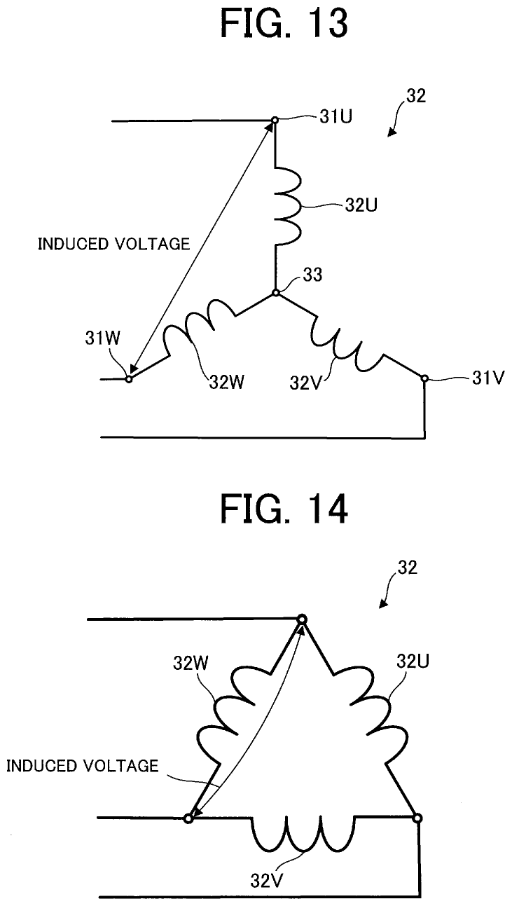

FIG. 13 is a diagram schematically illustrating the three-phase coils 32 connected by Y connection. That is, FIG. 13 is a diagram schematically illustrating the connection state of the three-phase coils 32 illustrated in FIG. 11.

FIG. 14 is a diagram schematically illustrating the three-phase coils 32 connected by delta connection. That is, FIG. 14 is a diagram schematically illustrating the connection state of the three-phase coils 32 illustrated in FIG. 12.

In the electric motor 1 in which the permanent magnets 22 are mounted on the rotor 2, when the rotor 2 rotates, magnetic flux from the permanent magnets 22 interlink with the three-phase coils 32 of the stator 3, and an induced voltage occurs in the three-phase coils 32. The induced voltage is proportional to the rotation speed of the rotor 2, and is also proportional to the number of turns of the three-phase coils 32. As the rotation speed of the electric motor 1 increases and the number of turns of the three-phase coils 32 increases, the induced voltage increases.

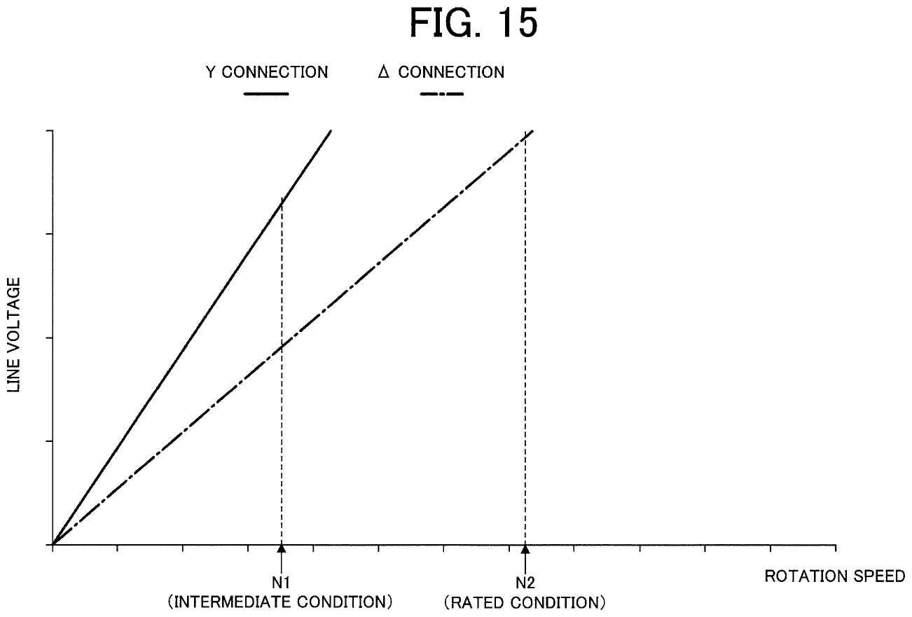

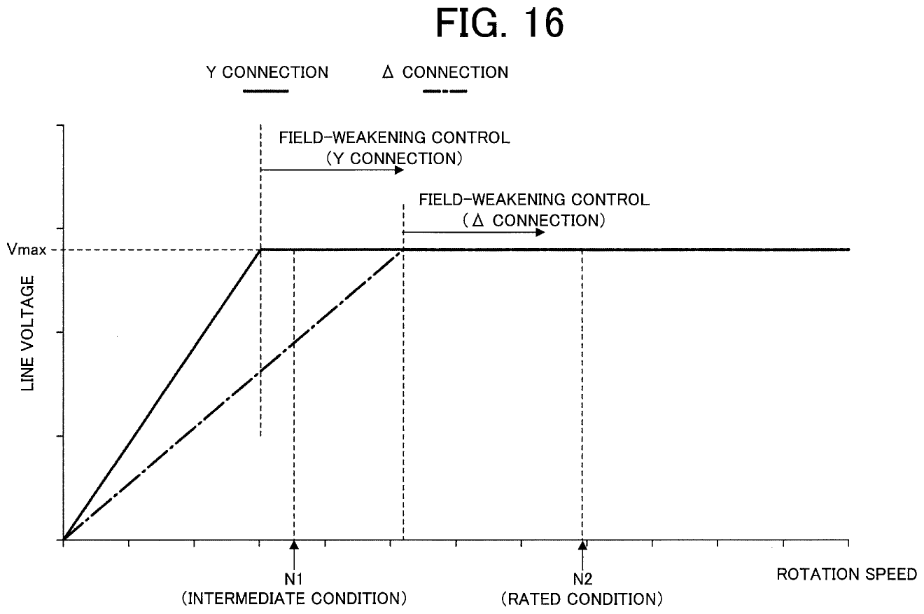

FIG. 15 is a graph showing a relationship between a line voltage and a rotation speed in the electric motor 1. In FIG. 15, a rotation speed N1 corresponds to an intermediate condition of an air conditioner (e.g., a refrigeration air conditioning apparatus 7 described in the sixth embodiment), and a rotation speed N2 corresponds to a rated condition of the air conditioner.

Delta connection (also referred to as Δ connection) reduces a line voltage of the three-phase coils 32 (also referred to as an electric motor voltage) below Y connection. A phase impedance of the three-phase coils 32 in the case where the connection state of the three-phase coils 32 is delta connection is 1/√3 as high as that in the case where the connection state of the three-phase coils 32 with the same number of turns is Y connection. Thus, as illustrated in FIG. 15, a line voltage in the case where the connection state of the three-phase coils 32 is delta connection is 1/√3 times as high as a line voltage in the case where the connection state of the three-phase coils 32 is Y connection at the same rotation speed.

That is, in the case where the three-phase coils 32 are connected by delta connection, when the number of turns is √3 times as large as that in the case of Y connection, the line voltage is equal to that in the case of Y connection with the same revolution speed N, and thus, an output current of the inverter 103 is equal to that in the case of Y connection.

An electric motor in which the number of turns around each tooth is several tens of turns or more, generally employs Y connection rather than delta connection for the following reasons. One reason is that delta connection uses a larger number of turns of a coil than Y connection, and thus, the time necessary for winding the three-phase coils is long in a fabrication process. Another reason is that a circulating current might be generated in the case of delta connection.

A magnet torque of the electric motor 1 is equal to a product of an induced voltage and a current flowing in the three-phase coils 32. That is, the induced voltage increases as the number of turns of the three-phase coils 32 increases. Thus, as the number of turns of the three-phase coils 32 increases, a smaller amount of current is needed for generating a necessary magnet torque. Consequently, a loss caused by electrification of the inverter 103 decreases, and thus efficiency of the electric motor 1 can be enhanced. On the other hand, with an increase in induced voltage, a line voltage dominated by the induced voltage reaches an inverter maximum output voltage (i.e., a bus voltage supplied from the converter 102 to the inverter 103) at a lower rotation rate, and the rotation speed cannot be increased any more.

When the number of turns of the three-phase coils 32 is reduced, an induced voltage decreases, and thus, the line voltage dominated by the induced voltage does not reach the inverter maximum output voltage until a higher rotation speed, and high-speed rotation can be performed. However, the decrease in the induced voltage increases a current for generating a necessary magnet torque, and thus, a loss due to energizing the inverter 103 increases and consequently efficiency of the electric motor 1 decreases.

From the viewpoint of a switching frequency of the inverter 103, as the line voltage is closer to the inverter maximum output voltage, a harmonic component due to an ON/OFF duty in switching of the inverter 103 decreases, and thus, an iron loss caused by a harmonic component of a current can be reduced.

FIG. 16 is a graph showing a relationship between a line voltage and a rotation speed in the electric motor 1.

In FIG. 16, a rotation speed N1 corresponds to an intermediate condition, and the rotation speed N2 corresponds to a rated condition. The line voltage is proportional to the rotation speed until the line voltage reaches a voltage Vmax corresponding to a maximum value of an inverter output voltage. In this case, the electric motor 1 can be operated with a load less than or equal to a maximum torque until the line voltage reaches the voltage Vmax.

As shown in FIG. 16, when the line voltage reaches the voltage Vmax, field-weakening control by the inverter 103 starts. The field-weakening control can reduce the linear voltage, and thus the rotation speed of the electric motor 1 can be increased.

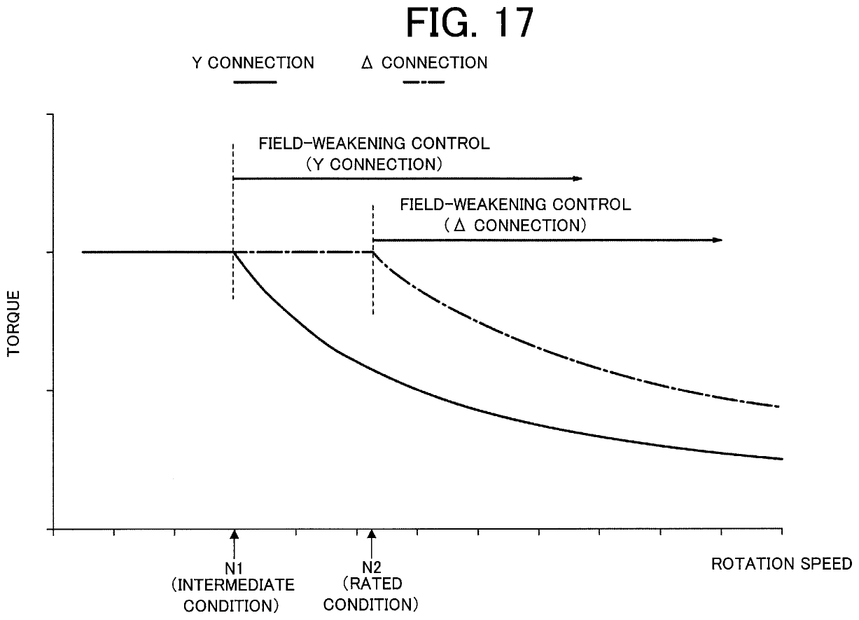

FIG. 17 is a graph showing a relationship between a torque and a rotation speed in the electric motor 1.

As shown in FIG. 17, after field-weakening control, the torque decreases as the rotation speed increases. Thus, to obtain a required torque, the rotation speed is restricted.

In field-weakening control, an induced voltage is weakened by causing a current of a d-axis phase (i.e., a direction in which the current cancels magnetic flux of the permanent magnets 22) to flow in the three-phase coils 32. This current will be referred to as a weakening current. In operation of an electric motor using field-weakening control, it is necessary to cause a weakening current to flow in addition to a general current for generating a motor torque. Thus, a copper loss due to resistance of the three-phase coils 32 increases, and an electrification loss of the inverter 103 increases.

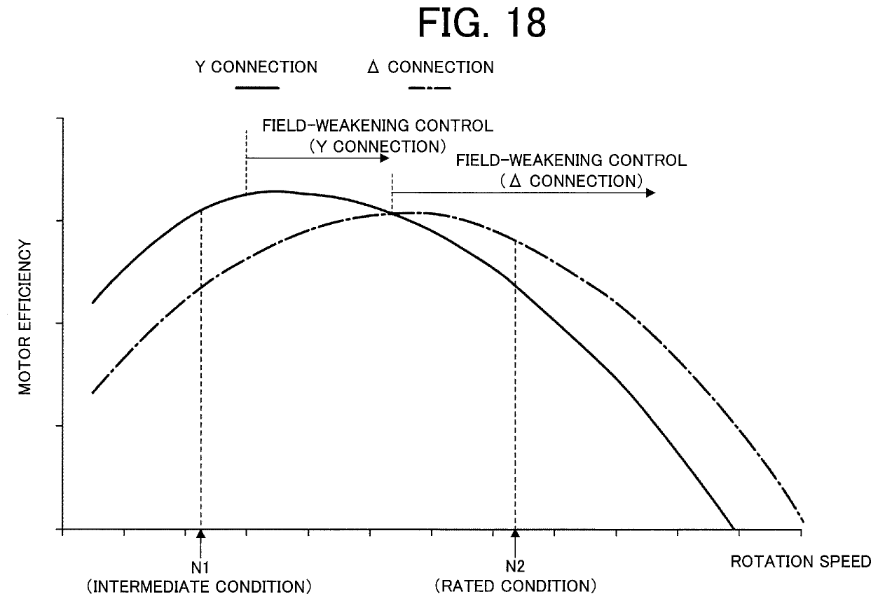

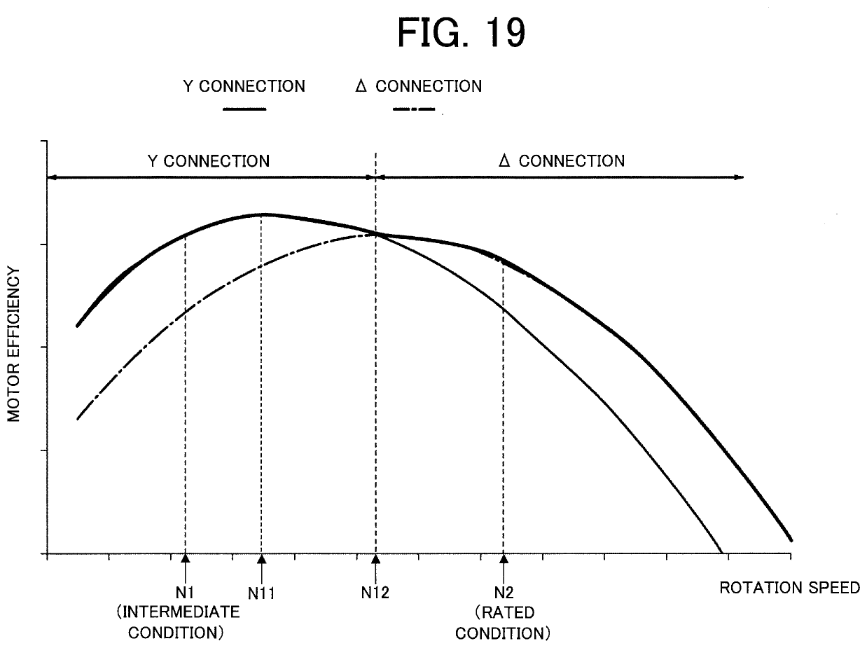

FIGS. 18 and 19 are graphs each showing a relationship between motor efficiency and a rotation speed.

In the case of performing field-weakening control slightly, reduction of an iron loss by weakening magnetic flux can exceed an electrification loss of the inverter 103. That is, as shown in FIG. 18, the motor efficiency increases together with the rotation speed, and the motor efficiency reaches its peak immediately after start of field-weakening control, but after the motor efficiency has reached the peak, the motor efficiency decreases together with the rotation speed. An overall efficiency including an inverter efficiency is expressed by motor efficiency×inverter. This overall efficiency also has properties shown in FIG. 18.

In FIG. 19, the rotation speeds N1, N11, N12, and N2 has a relationship of N1<N11<N12<N2. The rotation speed N12 is a rotation speed at which the motor efficiency in Y connection and the motor efficiency in delta connection coincide with each other. In the example illustrated in FIG. 19, a range less than or equal to the rotation speed N12 is a low-speed range, and a range higher than the rotation speed N12 is a high-speed range.

In this embodiment, since the number of turns is adjusted such that the line voltage reaches the inverter maximum output voltage in the low-speed range with a small induced voltage, as shown in FIG. 19, a high motor efficiency can be obtained at the rotation speed N11 in the case where the connection state of the three-phase coils 32 is Y connection. In this case, at the rotation speed N11, the line voltage is equal to the maximum value of the inverter output voltage.

In the example illustrated in FIG. 19, in a case where the rotation speed is higher than the rotation speed N12, the motor efficiency in delta connection is higher than the motor efficiency in Y connection. Thus, in a case where the rotation speed of the rotor 2 reaches the rotation speed N12 higher than the rotation speed N11, the control device 50 controls the connection switching unit 60 such that the connection state of the three-phase coils 32 is delta connection. The connection switching unit 60 sets the connection state of the three-phase coils 32 at delta connection based on an instruction of the control device 50. In this case, if the connection state of the three-phase coils 32 is Y connection, the connection switching unit 60 switches the connection state of the three-phase coils 32 from Y connection to delta connection. On the other hand, if the connection state of the three-phase coils 32 is already delta connection, the connection switching unit 60 does not change the connection state of the three-phase coils 32 and maintains delta connection. Thus, in the high-speed range with a high induced voltage, the connection state of the three-phase coils 32 is delta connection.

At a given rotation speed, a line voltage in the case where the connection state of the three-phase coils 32 is delta connection is 1/√3 times as high as a line voltage in the case where the connection state of the three-phase coils 32 is Y connection. Thus, when the connection state of the three-phase coils 32 switches from Y connection to delta connection, field weakening is suppressed, and motor efficiency is obtained in the high-speed range, and thus a decrease in torque can be suppressed.

In the case where the rotation speed of the rotor 2 reaches the rotation speed N12 from the rotation speed N11 as described above, the connection switching unit 60 switches the connection state of the three-phase coils 32 from Y connection to delta connection. As a result, as indicated by the bold line in FIG. 19, high motor efficiency can be obtained in both of the low-speed range (e.g., intermediate condition) and the high-speed range (e.g., rated condition).

When efficiencies such as compression efficiency of a compressor, operating efficiency of the compressor, and heat transfer coefficient of a heat exchanger are enhanced, energy consumption efficiency (coefficient of performance: COP) of an air conditioner increases. As a result, running costs (e.g., power consumption) and CO2 emission of the air conditioner are reduced.

The COP represents evaluation of performance in the case of operation in a given temperature condition, but the COP is not taken into account seasonal operation conditions of the air conditioner. However, in actual use of the air conditioner, capacity necessary for cooling or heating and power consumption change in accordance with a change in outdoor temperature. In view of this, to perform evaluation in a state close to actual use, an annual performance factor (APF) is used as an index of energy saving. The APF is obtained by defining a given model case and calculating an annual total load and a total power consumption.

In particular, in an electric motor to be driven by an inverter, capacity changes depending on the rotation rate of a compressor, and thus, there is a problem in performing evaluation close to actual use only with a rated condition.

The APF of an air conditioner is obtained by calculating a power consumption amount in accordance with an annual total load. As this amount increases, energy saving performance is evaluated to be higher.

In a breakdown of the annual total load, the proportion (e.g., 50%) of an intermediate condition is the highest, and the proportion (e.g., 25%) of a rated condition is the second largest. Thus, improving the motor efficiency under the intermediate condition and the rated condition is effective for enhancement of energy saving performance of the air conditioner.

The rotation speed of the electric motor of the compressor under the APF evaluation load condition varies depending on capacity of the air conditioner and performance of the heat exchanger. For example, in an air conditioner with a refrigeration capacity of 22.4 kW, the rotation speed N1 under the intermediate condition is 40 rps, and the rotation speed N2 under the rated condition is 90 rps.

### Comparative Examples

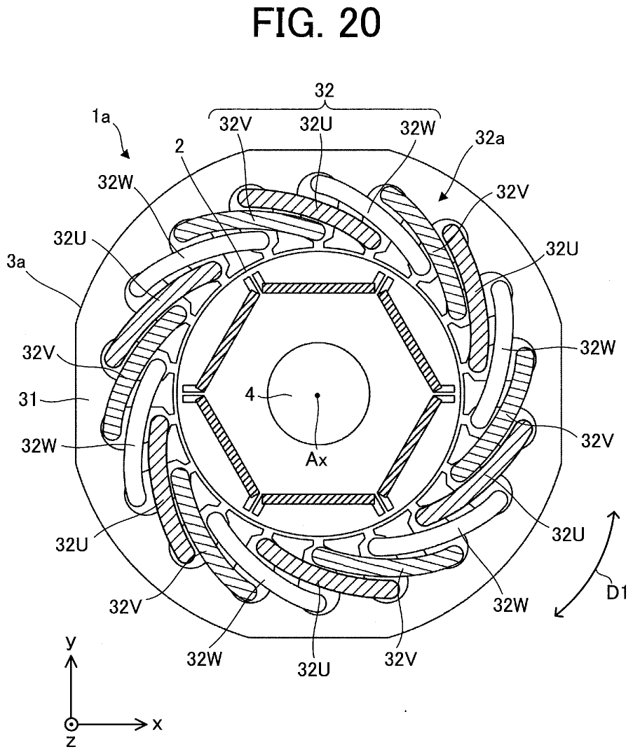

FIG. 20 is a top view illustrating an electric motor 1a according to a comparative example.

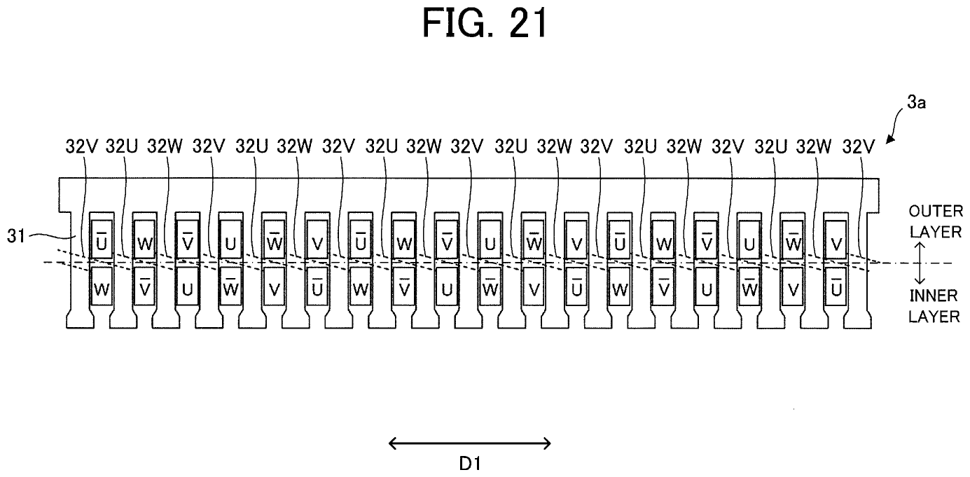

FIG. 21 is a diagram schematically illustrating arrangement of three-phase coils 32 and arrangement of the three-phase coils 32 in slots 311 in a coil end 32a of the electric motor 1a according to the comparative example. In FIG. 21, broken lines indicate coils of phases in the coil end 32a, and a chain line indicates a boundary between inner layers and outer layers in the slots 311.

In the comparative example, the three-phase coils 32 are attached to a stator core 31 by lap winding. In this case, in each coil end 32a, one end of each coil is disposed in an outer layer of a slot 311, and the other end of the coil is disposed in an inner layer of another slot 311.

Thus, in the case of attaching the three-phase coils 32 to the stator core 31 by lap winding, it is difficult to attach the three-phase coils 32 to the stator core 31 by using an inserter (e.g., the inserter 9 illustrated in FIG. 8). Thus, in general, in the case of attaching the three-phase coils 32 to the stator core 31 by lap winding as described in the comparative example, the three-phase coils 32 are manually attached to the stator core. In this case, productivity of the stator 3 decreases.

In the case of disposing two coils in each slot, an inductance difference occurs between the two coils in the slot. In this case, a current flowing in three-phase coils varies among the phases during driving of the electric motor, and thus a current does not easily flow in a phase with a large inductance and easily flows in a phase with a small inductance. Consequently, torque ripples occur.

In the case where the inductance difference occurs between the coil groups of each phase, a current does not flow uniformly in the coil groups, and an unbalanced current is generated. In this case, the amplitude of the current flowing in the coil group with small inductance increases, and a phase of the current progresses. The amplitude of the current flowing in the coil group with large inductance increases, and a phase of the current is delayed. Consequently, a torque of the electric motor is output with a phase shift, and thus, the sum of peak values of amplitudes of the current flowing in each coil group is larger than the sum of peak values of amplitudes of phase currents. Accordingly, losses such as a copper loss caused by resistance of coils increase. This phenomenon is conspicuous in a case where coils are connected in parallel in each phase.

### Advantages of Embodiment

In the stator 3 according to this embodiment, since the stator 3 has the arrangement of the three-phase coils 32 described above, an inductance balance in the three-phase coils 32 can be improved. Thus, an increase in torque ripples and an increase in losses can be suppressed in the electric motor 1 including the stator 3. Consequently, torque ripples due to an unbalanced current are improved.

In the case where the rotation speed of the rotor 2 reaches the rotation speed N12 from the rotation speed N11, the connection switching unit 60 switches the connection state of the three-phase coils 32 at delta connection. Thus, field weakening is suppressed, high motor efficiency is obtained in the high-speed range, and thus a decrease in torque can be suppressed.

In the case where the connection state of the three-phase coils 32 is Y connection, the rotor 2 rotates at the rotation speed N1 corresponding to the intermediate condition, for example. In the case where the connection state of the three-phase coils 32 is delta connection, the rotor 2 rotates at the rotation speed N2 corresponding to the rated condition, for example. That is, while the rotor 2 rotates at the rotation speed N1 corresponding to the intermediate condition, the connection state of the three-phase coils 32 is Y connection, whereas while the rotor 2 rotates at the rotation speed N2 corresponding to the rated condition, the connection state of the three-phase coils 32 is delta connection. As a result, high motor efficiency can be obtained in both of the low-speed range (e.g., intermediate condition) and the high-speed range (e.g., rated condition).

In the case where the connection state of the three-phase coils 32 is Y connection, the rotor 2 may rotate at the rotation speed N11. In this case, as shown in FIG. 19, motor efficiency can be obtained.

As described above, in this embodiment, efficiency of the electric motor 1 can be increased.

### Second Embodiment

In the second embodiment, a part of the configuration different from that of the first embodiment will be described. Parts of the configuration not described in the second embodiment are the same as those in the first embodiment.

In this embodiment, a first connection state is, for example, series connection in which coils of each phase in three-phase coils 32 are connected in series. The second connection state is different from the first connection state. In a case where the first connection state is series connection, the second connection state is parallel connection in which coils of each phase in the three-phase coils 32 are connected in parallel. That is, in this embodiment, the connection switching unit 60 switches the connection state of the three-phase coils 32 between series connection and parallel connection. Specifically, the control device 50 controls the connection switching unit 60, and the connection switching unit 60 switches the connection state of the three-phase coils 32 between series connection and parallel connection based on an instruction of the control device 50.

In this embodiment, in the case where the connection state of the three-phase coils 32 is series connection, for example, the rotor 2 rotates at a rotation speed N1 corresponding to an intermediate condition, whereas in the case where the connection state of the three-phase coils 32 is parallel connection, the rotor 2 rotates at the rotation speed N2 corresponding to the rated condition.

In this embodiment, (N2/N1)>m (m is an integer equal to or larger than 2). In this case, while the rotor 2 rotates at the rotation speed N1 corresponding to the intermediate condition, the connection state of the three-phase coils 32 is series connection, whereas while the rotor 2 rotates at the rotation speed N2 corresponding to the rated condition, the connection state of the three-phase coils 32 is parallel connection.

For example, in the case where (N2/N1)>m (m is an integer equal to or larger than 2) is satisfied, while the rotor 2 rotates at the rotation speed N1 corresponding to the intermediate condition, the control device 50 controls the connection switching unit 60 such that the connection state of the three-phase coils 32 is series connection. In the case where (N2/N1)>m (m is an integer equal to or larger than 2) is satisfied, while the rotor 2 rotates at the rotation speed N2 corresponding to the rated condition, the control device 50 controls the connection switching unit 60 such that the connection state of the three-phase coils 32 is parallel connection. As described above, N1 is a rotation speed corresponding to the intermediate condition, and N2 is a rotation speed corresponding to the rated condition.

The connection switching unit 60 sets the connection state of the three-phase coils 32 based on an instruction of the control device 50. In the case where the connection state of the three-phase coils 32 is set at parallel connection, if the connection state of the three-phase coils 32 is series connection, the connection switching unit 60 switches the connection state of the three-phase coils 32 from series connection to parallel connection. On the other hand, if the connection state of the three-phase coils 32 is already parallel connection, the connection switching unit 60 does not change the connection state of the three-phase coils 32 and maintains parallel connection.

In the case where (N2/N1)>m (m is an integer equal to or larger than 2) is satisfied, the control device 50 may control the connection switching unit 60 such that the connection state of the three-phase coils 32 is m parallel connection. In this case, the connection switching unit 60 sets the connection state of the three-phase coils 32 at m parallel connection based on an instruction of the control device 50. The m parallel connection refers to a connection state in which the number of coils of each phase in the three-phase coils 32 is m, and the m coils are connected in parallel in each phase. In this case, the first connection state is series connection, and the second connection state is m parallel connection.

In this embodiment, m=3. Thus, if the electric motor 1 satisfies 3<(N2/N1)<4, the second connection state is three parallel connection. In this case, in the case where the control device 50 controls the connection switching unit 60 such that the connection state of the three-phase coils 32 is three parallel connection, the connection switching unit 60 sets the connection state of the three-phase coils 32 at three parallel connection illustrated in FIG. 7, based on an instruction of the control device 50.

### Advantages of Second Embodiment

The electric motor 1 according to the second embodiment has the advantages described in the first embodiment.

The driving device 100 according to the second embodiment has the advantages described in the first embodiment.

In the case where the connection state of the three-phase coils 32 is series connection, the rotor 2 rotates at the rotation speed N1 corresponding to the intermediate condition, for example. In the case where the connection state of the three-phase coils 32 is parallel connection or m parallel connection, the rotor 2 rotates at the rotation speed N2 corresponding to the rated condition, for example. In this case, high motor efficiency can be obtained in both of the low-speed range (e.g., intermediate condition) and the high-speed range (e.g., rated condition).

In each phase of the three-phase coils 32, a line voltage in the case where the connection state of the three-phase coils 32 is parallel connection is lower than a line voltage in the case where the connection state of the three-phase coils 32 is series connection. Thus, in the intermediate condition, for example, the connection switching unit 60 sets the connection state of the three-phase coils 32 at series connection. In this embodiment, while (N2/N1)>m (m is an integer equal to or larger than 2) is satisfied and the rotor 2 rotates at the rotation speed N1 corresponding to the intermediate condition, the connection state of the three-phase coils 32 is series connection, whereas while the rotor 2 rotates at the rotation speed N2 corresponding to the rated condition, the connection state of the three-phase coils 32 is parallel connection. Consequently, field weakening is suppressed, and a balance of inductance among the phases is improved. As a result, efficiency of the electric motor 1 can be increased between the low-speed range and the high-speed range.

In each phase of the three-phase coils 32, a line voltage in the case where the connection state of the three-phase coils 32 is m parallel connection is 1/m of a line voltage in the case where the connection state of the three-phase coils 32 is series connection. Thus, if (N2/N1)>m (m is an integer equal to or larger than 2) is satisfied, the connection switching unit 60 preferably sets the connection state of the three-phase coils 32 at m parallel connection in the high-speed range such as the rated condition. Consequently, field weakening is suppressed, and a balance of inductance among the phases is improved. As a result, efficiency of the electric motor 1 can be increased between the low-speed range and the high-speed range.

### Third Embodiment

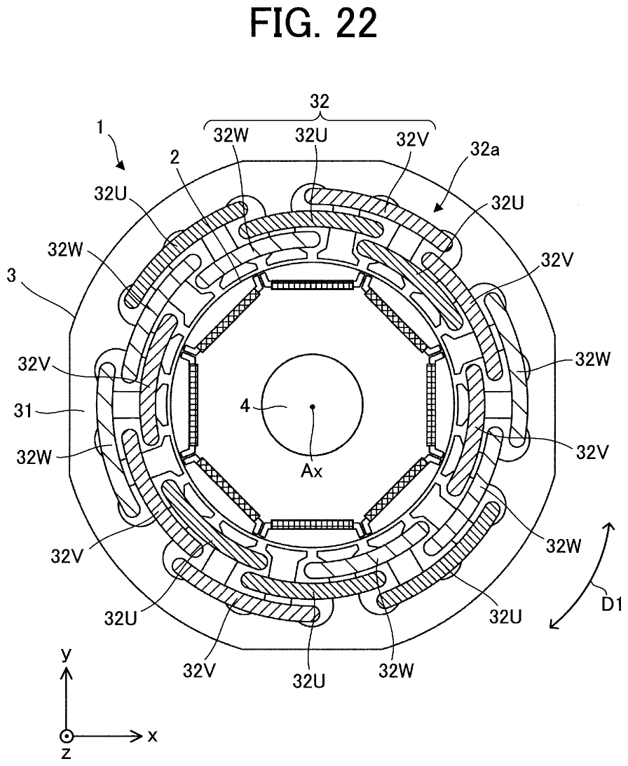

FIG. 22 is a top view schematically illustrating a structure of an electric motor 1 according to a third embodiment.

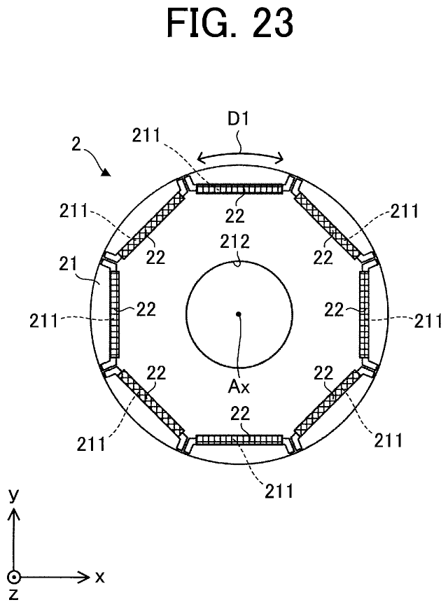

FIG. 23 is a cross-sectional view schematically illustrating a structure of a rotor 2 of the electric motor 1 illustrated in FIG. 22.

In the third embodiment, a part of the configuration different from those of the first and second embodiments will be described. Parts of the configuration not described in the third embodiment are the same as those in the first and second embodiments.

### <Rotor 2>

In this embodiment, the rotor 2 has 4×n (n is an integer equal to or larger than 1) magnetic poles.

### <Stator 3>

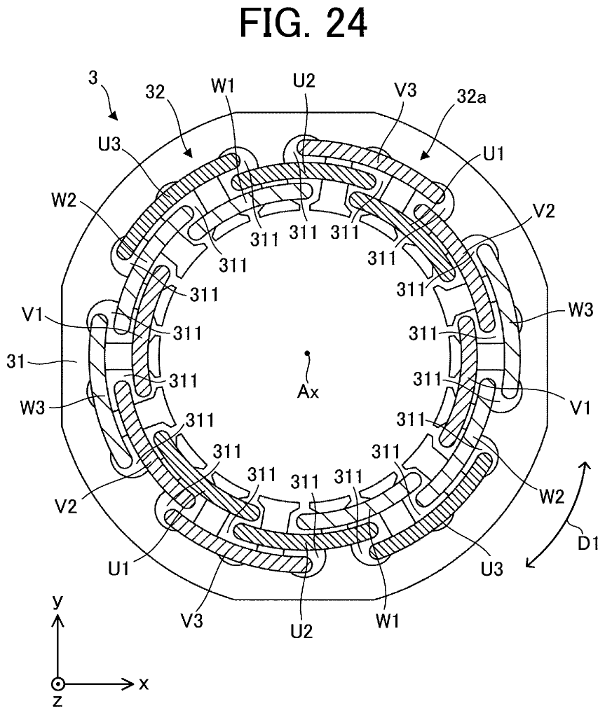

FIG. 24 is a top view schematically illustrating a structure of a stator 3 of the electric motor 1 illustrated in FIG. 22.

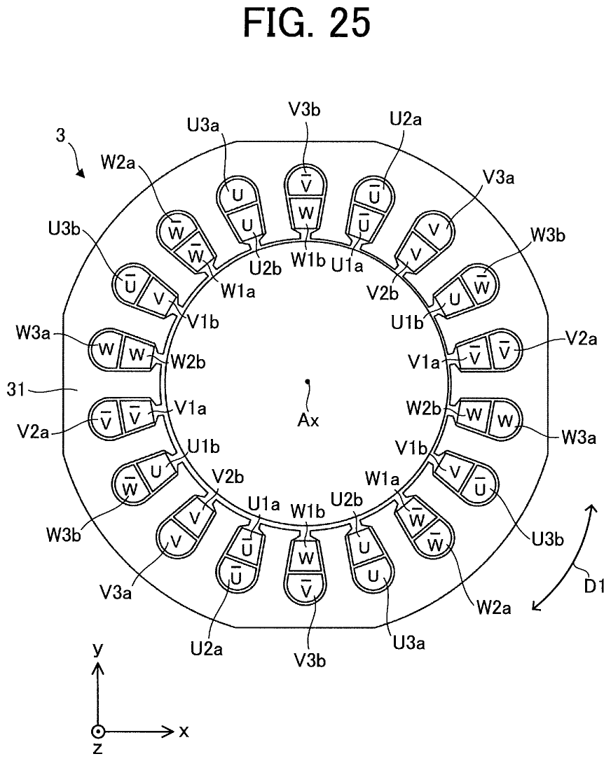

FIG. 25 is a diagram illustrating arrangement of three-phase coils 32 in slots 311 of the stator 3 illustrated in FIG. 24.

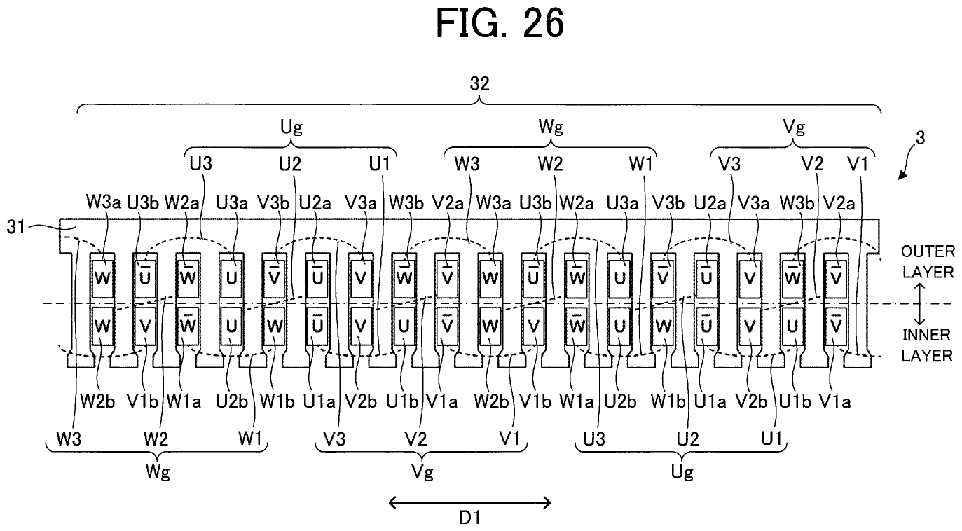

FIG. 26 is a diagram schematically illustrating arrangement of three-phase coils 32 and arrangement of the three-phase coils 32 in slots 311 in a coil end 32a of the stator 3 illustrated in FIG. 24. In FIG. 25, broken lines indicate coils of phases in the coil end 32a, and a chain line indicates a boundary between inner layers and outer layers in the slots 311.

As illustrated in FIG. 23, the stator 3 includes a stator core 31 and the three-phase coils 32 attached to the stator core 31 by distributed winding.

The stator core 31 includes 9×n (n is an integer equal to or larger than 1) slots 311 in which the three-phase coils 32 are disposed. As illustrated in FIGS. 25 and 26, each of the 9×n slots 311 includes an inner layer in which one of the three-phase coils 32 is disposed and an outer layer which is located outside the inner layer in the radial direction and in which one of the three-phase coils 32 is disposed. That is, in the example illustrated in FIGS. 25 and 26, space in each slot 311 is divided into the inner layer and the outer layer. In this embodiment, n=2. Thus, in the example illustrated in FIGS. 24 through 26, the stator core 31 includes 18 slots 311.

The three-phase coils 32 (i.e., coils of individual phases) include coil sides disposed in the slots 311 and coil ends 32a not disposed in the slots 311. Each coil end 32a is an end portion of the three-phase coil 32 in the axial direction.

In the coil ends 32a, the three-phase coils 32 include 3×n U-phase coils 32U, 3×n V-phase coils 32V, and 3×n W-phase coils 32W (see FIG. 22). That is, the three-phase coils 32 have three phases of a first phase, a second phase, and a third phase. For example, the first phase is a U phase, the second phase is a V phase, and the third phase is a W phase. In this embodiment, the three phases will be referred to as the U phase, the V phase, and the W phase, respectively. The U-phase coils 32U, the V-phase coils 32V, and the W-phase coils 32W illustrated in FIG. 22 will also be referred to simply as coils.

In this embodiment, n=2. Thus, in the example illustrated in FIG. 22, in each coil end 32a, the three-phase coils 32 include six U-phase coils 32U, six V-phase coils 32V, and six W-phase coils 32W. The number of coils of each phase are not limited to six. In this embodiment, the stator 3 has the structure illustrated in FIG. 3 in two coil ends 32a. It should be noted that the stator 3 only needs to have the structure illustrated in FIG. 22 in one of the two coil ends 32a.

When a current flows in the three-phase coils 32, the three-phase coils 32 form 4×n magnetic poles. In this embodiment, n=2. Thus, in this embodiment, when a current flows in the three-phase coils 32, the three-phase coils 32 form eight magnetic poles.

<Arrangement of Coils in Coil End 32a>

Arrangement of the three-phase coils 32 in each coil end 32a will be described below. As described above, each of the 3×n U-phase coils 32U, the 3×n V-phase coils 32V, and the 3×n W-phase coils 32W includes n sets of coil groups each of which is a set of first through third coils. In each coil end 32a, the n sets of coil groups are arranged at regular intervals in the circumferential direction of the stator 3. In each phase, one set of coil groups (also referred to as each coil group) is three coils arranged consecutively in the circumferential direction. In other words, in each phase, one set of coil groups is three coils adjacent to one another in the circumferential direction.

In the coil ends 32a of each phase, first through third coils constituting each coil group are arranged in this order in the circumferential direction of the stator 3. In the coil ends 32a of each phase, the first through third coils constituting each coil group are arranged in this order in the radial direction of the stator 3.

In the coil ends 32a, at least two of the first through third coils of at least one phase are adjacent to each other in the radial direction. In this embodiment, in the coil ends 32a, the first coil and the second coil of each phase are adjacent to each other in the radial direction, and the second coil and the third coil of each phase are adjacent to each other in the radial direction.

In the coil ends 32a of each phase, a region where the first through third coils of each of the n sets of coil groups are arranged is divided into an inner region, an intermediate region, and an outer region. The inner region is a region closest to the center of the stator core 31. The outer region is a region most away from the center of the stator core 31. The intermediate region is a region locate between the inner region and the outer layer. In this embodiment, in the coil ends 32a of each coil group, the first coil is disposed in the inner region, the second coil is disposed in the intermediate region, and the third coil is disposed in the outer region. That is, in the coil ends 32a of each coil group, the first coil is disposed inside the second coil in the radial direction, the third coil is disposed outside the second coil in the radial direction, and the second coil is disposed between the first coil and the third coil.

As illustrated in FIGS. 22 and 24, the coils of the three-phase coils 32 are disposed in the slots 311 at a two-slot pitch on one end side of the stator core 31. In other words, the two-slot pitch means that one coil is disposed across one slot in the slots 311. Thus, as illustrated in FIGS. 22 and 24, each coil of the three-phase coils 32 is disposed in the two slots 311 across one slot on one end side of the stator core 31. In other words, each coil of the three-phase coils 32 is disposed in two slots 311 with one slot 311 interposed therebetween on one end side of the stator core 31.

As illustrated in FIG. 24, in the coil ends 32a, three U-phase coils 32U adjacent to one another in the circumferential direction will be referred to as a first coil U1, a second coil U2, and a third coil U3, respectively. As illustrated in FIG. 24, in the coil ends 32a, three V-phase coils 32V adjacent to one another in the circumferential direction will be referred to as a first coil V1, a second coil V2, and a third coil V3, respectively. As illustrated in FIG. 24, in the coil ends 32a, three W-phase coils 32W adjacent to one another in the circumferential direction will be referred to as a first coil W1, a second coil W2, and a third coil W3, respectively. The first coils U1, the second coils U2, the third coils U3, the first coils V1, the second coils V2, the third coils V3, the first coils W1, the second coils W2, and the third coils W3 will also be referred to simply as coils.

### <U-Phase Coils 32U>

As illustrated in FIG. 26, the six U-phase coils 32U include two sets of coil groups Ug in which the first through third coils U1, U2, and U3 adjacent to one another in the circumferential direction are defined as one set in each coil end 32a. In other words, the six U-phase coils 32U include the two sets of coil groups Ug, each coil group Ug of the six U-phase coils 32U includes the first coil U1, the second coil U2, and the third coil U3 adjacent to one another in the circumferential direction in each coil end 32a.

In each coil end 32a, n sets of coil groups Ug of the six U-phase coils 32U are arranged at regular intervals in the circumferential direction of the stator 3. In each coil end 32a, the first coil U1, the second coil U2, and the third coil U3 of each coil group Ug are arranged in this order in the circumferential direction of the stator 3.

In this embodiment, in each coil end 32a, the first coil U1, the second coil U2, and the third coil U3 of each coil group Ug are arranged in this order in the radial direction of the stator 3. In other words, in each coil end 32a, the first coil U1, the second coil U2, and the third coil U3 of each coil group Ug are arranged in this order in the radial direction of the stator 3 from the inner side of the stator core 31. The first coil U1, the second coil U2, and the third coil U3 of each coil group Ug are connected in series. The second coil U2 of each coil group Ug is wound around the stator core 31 in a direction opposite to the other two coils U1 and U3.

A part of the first coil U1 and a part of the second coil U2 of each coil group Ug are disposed in one of 18 slots 311. In this case, another part of the second coil U2 and another part of the third coil U3 of the coil group Ug are disposed in another slot 311 of the 18 slots 311.

Another part of the first coil U1 of each coil group Ug is disposed in one slot 311 together with a part of a coil of another phase. Another part of the third coil U3 of each coil group Ug is disposed in one slot 311 together with a part of a coil of another phase.

For example, in FIGS. 25 and 26, a part of the first coil U1 is a first portion U1a of the first coil U1, another part of the first coil U1 is a second portion U1b of the first coil U1, a part of the second coil U2 is a first portion U2a of the second coil U2, another part of the second coil U2 is a second portion U2b of the second coil U2, a part of the third coil U3 is a first portion U3a of the third coil U3, and another part of the third coil U3 is a second portion U3b of the third coil U3.

In this application, a part of the first coil U1 may be replaced by the second portion U1b of the first coil U1, another part of the first coil U1 may be replaced by the first portion U1a of the first coil U1, a part of the second coil U2 may be replaced by the second portion U2b of the second coil U2, another part of the second coil U2 may be replaced by the first portion U2a of the second coil U2, a part of the third coil U3 may be replaced by the second portion U3b of the third coil U3, and another part of the third coil U3 may be replaced by the first portion U3a of the third coil U3.

### <V-Phase Coils 32V>

As illustrated in FIG. 26, the six V-phase coils 32V include two sets of coil groups Vg in which the first through third coils V1, V2, and V3 adjacent to one another in the circumferential direction are defined as one set in each coil end 32a. In other words, the six V-phase coils 32V include the two sets of coil groups Vg, each coil group Vg of the six V-phase coils 32V includes the first coil V1, the second coil V2, and the third coil V3 adjacent to one another in the circumferential direction in each coil end 32a.

In each coil end 32a, n sets of coil groups Vg of the six V-phase coils 32V are arranged at regular intervals in the circumferential direction of the stator 3. In each coil end 32a, the first coil V1, the second coil V2, and the third coil V3 of each coil group Vg are arranged in this order in the circumferential direction of the stator 3.

In this embodiment, in each coil end 32a, the first coil V1, the second coil V2, and the third coil V3 of each coil group Vg are arranged in this order in the radial direction of the stator 3. In other words, in each coil end 32a, the first coil V1, the second coil V2, and the third coil V3 of each coil group Vg are arranged in this order in the radial direction of the stator 3 from the inner side of the stator core 31. The first coil V1, the second coil V2, and the third coil V3 of each coil group Vg are connected in series. The second coil V2 of each coil group Vg is wound around the stator core 31 in a direction opposite to the other two coils V1 and V3.

A part of the first coil V1 and a part of the second coil V2 of each coil group Vg are disposed in one of 18 slots 311. In this case, another part of the second coil V2 and another part of the third coil V3 of the coil group Vg are disposed in another slot 311 of the 18 slots 311.

Another part of the first coil V1 of each coil group Vg is disposed in one slot 311 together with a part of a coil of another phase. Another part of the third coil V3 of each coil group Vg is disposed in one slot 311 together with a part of a coil of another phase.

For example, in FIGS. 25 and 26, a part of the first coil V1 is a first portion Via of the first coil V1, another part of the first coil V1 is a second portion V1b of the first coil V1, a part of the second coil V2 is a first portion V2a of the second coil V2, another part of the second coil V2 is a second portion V2b of the second coil V2, a part of the third coil V3 is a first portion V3a of the third coil V3, and another part of the third coil V3 is a second portion V3b of the third coil V3.

In this application, a part of the first coil V1 may be replaced by the second portion V1b of the first coil V1, another part of the first coil V1 may be replaced by the first portion Via of the first coil V1, a part of the second coil V2 may be replaced by the second portion V2b of the second coil V2, another part of the second coil V2 may be replaced by the first portion V2a of the second coil V2, a part of the third coil V3 may be replaced by the second portion V3b of the third coil V3, and another part of the third coil V3 may be replaced by the first portion V3a of the third coil V3.

### <W-Phase Coils 32W>

As illustrated in FIG. 26, the six W-phase coils 32W include two sets of coil groups Wg in which the first through third coils W1, W2, and W3 adjacent to one another in the circumferential direction are defined as one set in each coil end 32a. In other words, the six W-phase coils 32W include the two sets of coil groups Wg, each coil group Wg of the six W-phase coils 32W includes the first coil W1, the second coil W2, and the third coil W3 adjacent to one another in the circumferential direction in each coil end 32a.

In each coil end 32a, n sets of coil groups Wg of the six W-phase coils 32W are arranged at regular intervals in the circumferential direction of the stator 3. In each coil end 32a, the first coil W1, the second coil W2, and the third coil W3 of each coil group Wg are arranged in this order in the circumferential direction of the stator 3.

In this embodiment, in each coil end 32a, the first coil W1, the second coil W2, and the third coil W3 of each coil group Wg are arranged in this order in the radial direction of the stator 3. In other words, in each coil end 32a, the first coil W1, the second coil W2, and the third coil W3 of each coil group Wg are arranged in this order in the radial direction of the stator 3 from the inner side of the stator core 31. The first coil W1, the second coil W2, and the third coil W3 of each coil group Wg are connected in series. The second coil W2 of each coil group Wg is wound around the stator core 31 in a direction opposite to the other two coils W1 and W3.

A part of the first coil W1 and a part of the second coil W2 of each coil group Wg are disposed in one of 18 slots 311. In this case, another part of the second coil W2 and another part of the third coil W3 of the coil group Wg are disposed in another slot 311 of the 18 slots 311.

Another part of the first coil W1 of each coil group Wg is disposed in one slot 311 together with a part of a coil of another phase. Another part of the third coil W3 of each coil group Wg is disposed in one slot 311 together with a part of a coil of another phase.

For example, in FIGS. 25 and 26, a part of the first coil W1 is a first portion W1a of the first coil W1, another part of the first coil W1 is a second portion W1b of the first coil W1, a part of the second coil W2 is a first portion W2a of the second coil W2, another part of the second coil W2 is a second portion W2b of the second coil W2, a part of the third coil W3 is a first portion W3a of the third coil W3, and another part of the third coil W3 is a second portion W3b of the third coil W3.

In this application, a part of the first coil W1 may be replaced by the second portion W1b of the first coil W1, another part of the first coil W1 may be replaced by the first portion W1a of the first coil W1, a part of the second coil W2 may be replaced by the second portion W2b of the second coil W2, another part of the second coil W2 may be replaced by the first portion W2a of the second coil W2, a part of the third coil W3 may be replaced by the second portion W3b of the third coil W3, and another part of the third coil W3 may be replaced by the first portion W3a of the third coil W3.

### <Summary of Arrangement of Coils in Slots 311>

As illustrated in FIGS. 25 and 26, the first coil of each phase in the three-phase coils 32 is disposed in the inner layer of the slots 311. The second coil of each phase in the three-phase coils 32 is disposed in the inner layer or the outer layer of the slots 311. The third coil of each phase in the three-phase coils 32 is disposed in the outer layer of the slots 311.

Thus, as illustrated in FIGS. 25 and 26, coils of each phase are disposed in six outer layers and in six inner layers. In each coil group, two coils adjacent to each other in the radial direction are disposed in the same slot 311. In each phase, for example, a part of the first coil and a part of the second coil are disposed in the same slot 311 (e.g., the first slot 311), and another part of the second coil and another part of the third coil are disposed in another slot (e.g., the second slots 311).

### <Arrangement of U-Phase Coils 32U in Slots 311>

Arrangement of the U-phase coils 32U in the slots 311 will be specifically described.

A part of each first coil of the U-phase coils 32U is disposed in the inner layer of the slot 311 in which a corresponding one of the second coils of the U-phase coils 32U is disposed. Another part of each first coil of the U-phase coils 32U is disposed in the inner layer of the slot 311 in which a corresponding one of the third coils of the W-phase coils 32W is disposed. Thus, another part of each first coil of the U-phase coils 32U is disposed inside the third coil of the W-phase coils 32W in the radial direction in the slot 311.

A part of each second coil of the U-phase coils 32U is disposed in the outer layer of the slot 311 in which a corresponding one of the first coils of the U-phase coils 32U is disposed. Another part of each second coil of the U-phase coils 32U is disposed in the inner layer of the slot 311 in which a corresponding one of the third coils of the U-phase coils 32U is disposed.

A part of each third coil of the U-phase coils 32U is disposed in the outer layer of the slot 311 in which a corresponding one of the second coils of the U-phase coils 32U is disposed. Another part of each third coil of the U-phase coils 32U is disposed in the outer layer of the slot 311 in which a corresponding one of the first coils of the V-phase coils 32V is disposed. Thus, another part of each third coil of the U-phase coils 32U is disposed outside the first coil of the V-phase coils 32V in the radial direction in the slot 311.

### <Arrangement of V-Phase Coils 32V in Slots 311>

Arrangement of the V-phase coils 32V in the slots 311 will be specifically described.

A part of each first coil of the V-phase coils 32V is disposed in the inner layer of the slot 311 in which a corresponding one of the second coils of the V-phase coils 32V is disposed. Another part of each first coil of the V-phase coils 32V is disposed in the inner layer of the slot 311 in which a corresponding one of the third coils of the U-phase coils 32U is disposed. Thus, another part of each first coil of the V-phase coils 32V is disposed inside the third coil of the U-phase coils 32U in the radial direction in the slot 311.

A part of each second coil of the V-phase coils 32V is disposed in the outer layer of the slot 311 in which a corresponding one of the first coils of the V-phase coils 32V is disposed. Another part of each second coil of the V-phase coils 32V is disposed in the inner layer of the slot 311 in which a corresponding one of the third coils of the V-phase coils 32V is disposed.

A part of each third coil of the V-phase coils 32V is disposed in the outer layer of the slot 311 in which a corresponding one of the second coils of the V-phase coils 32V is disposed. Another part of each third coil of the V-phase coils 32V is disposed in the outer layer of the slot 311 in which a corresponding one of the first coils of the W-phase coils 32W is disposed. Thus, another part of each third coil of the V-phase coils 32V is disposed outside the first coil of the W-phase coils 32W in the radial direction in the slot 311.

### <Arrangement of W-Phase Coils 32W in Slots 311>

Arrangement of the W-phase coils 32W in the slots 311 will be specifically described.

A part of each first coil of the W-phase coils 32W is disposed in the inner layer of the slots 311 in which a corresponding one of the second coils of the W-phase coils 32W is disposed. Another part of each first coil of the W-phase coils 32W is disposed in the inner layer of the slot 311 in which a corresponding one of the third coils of the V-phase coils 32V is disposed. Thus, another part of each first coil of the W-phase coils 32W is disposed inside the third coil of the V-phase coils 32V in the radial direction in the slot 311.

A part of each second coil of the W-phase coils 32W is disposed in the outer layer of the slots 311 in which a corresponding one of the first coils of the W-phase coils 32W is disposed. Another part of each second coil of the W-phase coils 32W is disposed in the inner layer of the slot 311 in which a corresponding one of the third coils of the W-phase coils 32W is disposed.

A part of each third coil of the W-phase coils 32W is disposed in the outer layer of the slot 311 in which a corresponding one of the second coils of the W-phase coils 32W is disposed. Another part of each third coil of the W-phase coils 32W is disposed in the outer layer of the slot 311 in which a corresponding one of the first coils of the U-phase coils 32U is disposed. Thus, another part of each third coil of the W-phase coils 32W is disposed outside the first coil of the U-phase coils 32U in the radial direction in the slot 311.

<Winding Factor of Electric Motor with Full-Pitch Winding>

In an electric motor with full-pitch winding, three slots correspond to one magnetic pole of a rotor, and coils are arranged at three-slot pitch in slots. The three-slot pitch means that one coil is disposed across two slots in the slots 311. In a case where the number of magnetic poles of the three-phase coils is 6, the number of slots is 18, the slot pitch number is 3, and the number of slots per pole per phase is 1, a short-pitch factor kp of a fundamental wave of each coil, and a winding factor kd of a fundamental wave of each coil, and a winding factor kw of a fundamental wave of the electric motor are obtained by the following equations:

kp=sin{6/(18/3)}×(π/2)=1

kd={sin(π/6)}/[1×sin{(π/6)/1}]=1

kw=kp×kd=1×1=1

In a case where the number of magnetic poles of the three-phase coils is 6, the number of slots is 18, the slot pitch number is 3, and the number of slots per pole per phase is 1, a third short-pitch factor kp3 of each coil is obtained by the following equation:

kp3=sin{3×6/(18/3)}×(π/2)=1

In a case where the number of slots per pole per phase is 1, a third distributed winding factor kd is obtained by the following equation:

kd3={sin(3×π/6)}/[1×sin{(3×π/6)/1}]=1

In this case, a third winding factor kw3 is obtained by the following equation:

kw3=kp3×kd3=1×1=1

Thus, in the electric motor with full-pitch winding, since the third winding factor is 1, a circulating current due to a third harmonic component of an induced voltage is generated in the three-phase coils, and thus performance of the electric motor might degrade.

### <Winding Factor of Fundamental Wave>

On the other hand, in the electric motor 1 according to this embodiment, two slots 311 correspond to one magnetic pole of the rotor 2, and the coils are arranged in the slots 311 at a two-slot pitch. Thus, a short-pitch factor kp of a fundamental wave of each coil is obtained by the following equation:

kp=sin{P/(Q/S)}×(π/2)

In this embodiment, P=8, Q=18, and S=2, where P is the number of magnetic poles of the three-phase coils 32, Q is the number of slots 311, and S is a slot pitch number. Thus,

kp=sin{(8/9)×(π/2)}=0.985.

Supposing the number of slots per pole per phase is q, a distributed winding factor kd of a fundamental wave is obtained by the following equation:

kd={sin(π/6)}/[q×sin{(π/6)/q}]

In this embodiment, q=3. Thus, kd=0.960.

Accordingly, in this embodiment, a winding factor kw of a fundamental wave of the electric motor 1 is obtained by the following equation:

kw=kp×kd=0.985×0.960=0.945

### <Third Winding Factor>

In the electric motor 1 according to this embodiment, two slots 311 correspond to one magnetic pole of the rotor 2, and the coils are arranged in the slots 311 at a two-slot pitch. Thus, a third short-pitch factor kp3 of each coil is obtained by the following equation:

kp3=sin{3×P/(Q/S)}×(π/2)

In this embodiment, P=8, Q=18, and S=2, where P is the number of magnetic poles of the three-phase coils 32, Q is the number of slots 311, and S is a slot pitch number. Thus,

kp3=sin{(3×8/9)×(π/2)}=0.866.

Supposing the number of slots per pole per phase is q, a third distributed winding factor kd is obtained by the following equation:

kd3={sin(3×π/6)}/[q×sin{(3×π/6)/q}]

In this embodiment, q=3. Thus, kd3=0.667.

Accordingly, in this embodiment, a third winding factor kw3 of the electric motor 1 is obtained by the following equation:

kw3=kp3×kd3=0.866×0.667=0.578

### Advantages of Third Embodiment

The electric motor 1 according to the third embodiment has the advantages described in the first and second embodiments.

In this embodiment, since the stator 3 has the arrangement of the three-phase coils 32 described above, especially a third winding factor is reduced, and thus degradation of performance of the electric motor 1 caused by a circulating current can be prevented. As a result, in a manner similar to the first embodiment, high motor efficiency can be obtained in both of the low-speed range (e.g., intermediate condition) and the high-speed range (e.g., rated condition).

### Fourth Embodiment

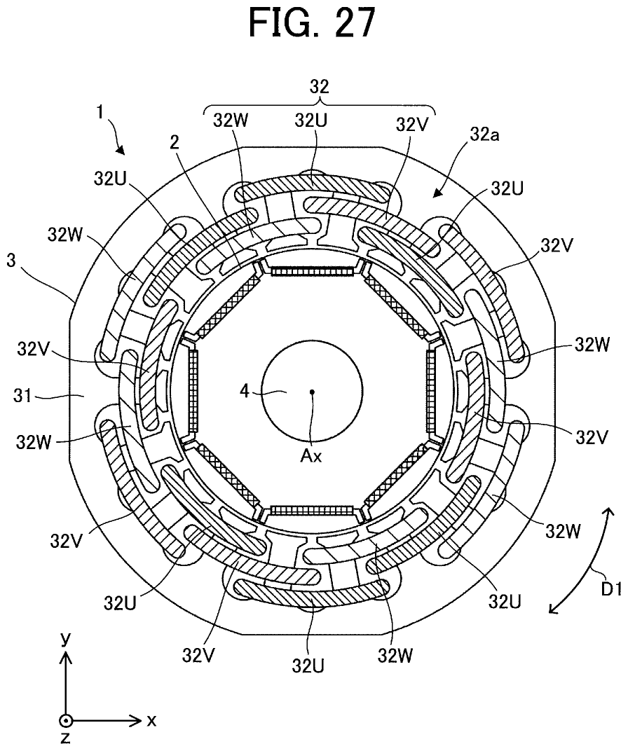

FIG. 27 is a top view schematically illustrating a structure of an electric motor 1 according to a fourth embodiment.

In the fourth embodiment, configurations different from those of the first, second, and third embodiments will be described. Configurations not described in the fourth embodiment are the same as those in the first, second, and third embodiments.

### <Rotor 2>

A rotor 2 according to the fourth embodiment is the same as the rotor 2 of the third embodiment.

### <Stator 3>

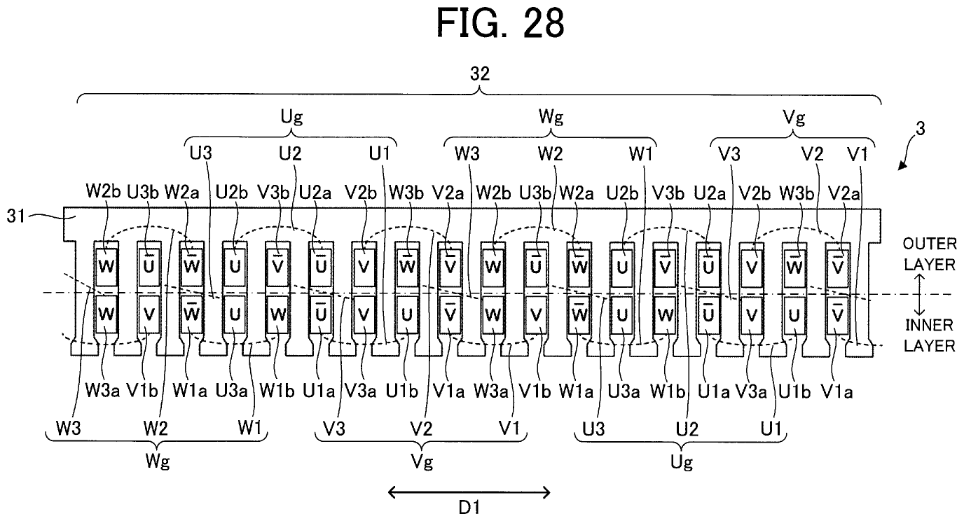

FIG. 28 is a diagram schematically illustrating arrangement of three-phase coils 32 in a coil end 32a and arrangement of the three-phase coils 32 in slots 311 in the stator 3 of the electric motor 1 illustrated in FIG. 27. FIG. 28 is a development view of the stator 3 illustrated in FIG. 27. In FIG. 28, broken lines indicate coils of phases in the coil end 32a, and a chain line indicates a boundary between inner layers and outer layers in the slots 311.

In the example illustrated in FIGS. 27 and 28, a stator core 31 includes 18 slots 311 in a manner similar to the first embodiment.

<Arrangement of Coils in Coil End 32a>

Arrangement of the three-phase coils 32 in the coil ends 32a will be described below. As described above, each of the 3×n U-phase coils 32U, the 3×n V-phase coils 32V, and the 3×n W-phase coils 32W includes n sets of coil groups each of which is a set of first through third coils. In this embodiment, n=2. In the coil ends 32a, the n sets of coil groups are arranged at regular intervals in the circumferential direction of the stator 3. In each phase, one set of coil groups (also referred to as each coil group) is three coils arranged consecutively in the circumferential direction. In other words, in each phase, one set of coil groups is three coils adjacent to one another in the circumferential direction.

In each coil end 32a, the n sets of coil groups are arranged at regular intervals in the circumferential direction of the stator 3. In the coil end 32a of each phase, the first through third coils constituting each coil group are arranged in this order at a two-slot pitch in the circumferential direction of the stator 3. In the coil end 32a, at least two of the first through third coils of at least one phase are adjacent to each other in the radial direction. In this embodiment, in each coil end 32a, the second coil and the third coil of each phase are adjacent to each other in the radial direction.

In the coil end 32a of each phase, the second coil in the first through third coils constituting each coil group is disposed outside the first coil and the third coil in the radial direction of the stator 3, and one of the first coil and the third coil is closer to the center of the stator core 31 than the other. That is, in the coil end 32a of each phase, one of the first coil and the third coil is closer to the axis Ax than the other. Specifically, in the coil end 32a of each phase, the first coil is closer to the center of the stator core 31 than the third coil.

In this embodiment, in the coil end 32a of each coil group, the first coil is disposed in the inner region, the second coil is disposed in the outer region, and the third coil is disposed in the intermediate region. That is, in the coil end 32a of each coil group, the first coil is disposed inside the second coil in the radial direction, the second coil is disposed outside the third coil in the radial direction, and the third coil is disposed between the first coil and the second coil.

Each third coil is disposed between the first coil of another adjacent phase and the second coil of another phase. For example, the third coil of the V phase is disposed between the first coil of the U phase and the second coil of the U phase. Accordingly, in the coil end 32a of each coil group, the first coil is separated from the second coil.

### <Summary of Arrangement of Coils in Slots 311>

The first coils in the coils of each phase in the three-phase coils 32 are disposed in the inner layers of the slots 311. The second coils in the coils of each phase in the three-phase coils 32 are disposed in the outer layers of the slots 311. The third coils in the coils of each phase in the three-phase coils 32 are disposed in the inner layers or the outer layers of the slots 311.

That is, the first coils are disposed in the inner layers of the slots 311, and the second coils are disposed in the outer layers of the slots 311. A part of each third coil is disposed in the inner layer of the slot 311, and another part of each third coil is disposed in the outer layer of another slot 311.

Accordingly, the coils of the phases are disposed in six outer layers of the slots 311 and in six inner layers of the slots 311.

### <Arrangement of U-Phase Coils 32U in Slots 311>

Arrangement of the U-phase coils 32U in the slots 311 will be specifically described.

A part of each first coil of the U-phase coils 32U is disposed in the inner layer of the slot 311 in which a corresponding one of the second coils of the U-phase coils 32U is disposed. Another part of each first coil of the U-phase coils 32U is disposed in the inner layer of the slot 311 in which a corresponding one of the third coils of the W-phase coils 32W is disposed. Thus, another part of each first coil of the U-phase coils 32U is disposed inside the third coil of the W-phase coils 32W in the radial direction in the slot 311.

A part of each second coil of the U-phase coils 32U is disposed in the outer layer of the slot 311 in which a corresponding one of the first coils of the U-phase coils 32U is disposed. Another part of each second coil of the U-phase coils 32U is disposed in the outer layer of the slot 311 in which a corresponding one of the third coils of the U-phase coils 32U is disposed.

A part of each third coil of the U-phase coils 32U is disposed in the inner layer of the slot 311 in which a corresponding one of the second coils of the U-phase coils 32U is disposed. Another part of each third coil of the U-phase coils 32U are disposed in the outer layer of the slot 311 in which a corresponding one of the first coils of the V-phase coils 32V is disposed. Thus, another part of each third coils of the U-phase coils 32U is disposed outside the first coil in the V-phase coils 32V in the radial direction in the slot 311.

### <Arrangement of V-Phase Coils 32V in Slots 311>

Arrangement of the V-phase coils 32V in the slots 311 will be specifically described.

A part of each first coil of the V-phase coils 32V is disposed in the inner layer of the slot 311 in which a corresponding one of the second coils of the V-phase coils 32V is disposed. Another part of each first coil of the V-phase coils 32V is disposed in the inner layer of the slot 311 in which a corresponding one of the third coils of the U-phase coils 32U is disposed. Thus, another part of each first coil of the V-phase coils 32V is disposed inside the third coil of the U-phase coils 32U in the radial direction in the slot 311.

A part of each second coil of the V-phase coils 32V is disposed in the outer layer of the slot 311 in which a corresponding one of the first coils of the V-phase coils 32V is disposed. Another part of each second coil of the V-phase coils 32V is disposed in the outer layer of the slot 311 in which a corresponding one of the third coils of the V-phase coils 32V is disposed.

A part of each third coil of the V-phase coils 32V is disposed in the inner layer of the slot 311 in which a corresponding one of the second coils of the V-phase coils 32V is disposed. Another part of each third coil of the V-phase coils 32V is disposed in the outer layer of the slot 311 in which a corresponding one of the first coils of the W-phase coils 32W is disposed. Thus, another part of each third coil of the V-phase coils 32V is disposed outside the first coil of the W-phase coils 32W in the radial direction in the slot 311.

### <Arrangement of W-Phase Coils 32W in Slots 311>

Arrangement of the W-phase coils 32W in the slots 311 will be specifically described below.

A part of each first coil of the W-phase coils 32W is disposed in the inner layer of the slot 311 in which a corresponding one of the second coils of the W-phase coils 32W is disposed. Another part of each first coil of the W-phase coils 32W is disposed in the inner layer of the slot 311 in which a corresponding one of the third coils of the V-phase coils 32V is disposed. Thus, another part of each first coil of the W-phase coils 32W is disposed inside the third coil of the V-phase coils 32V in the radial direction in the slot 311.

A part of each second coil of the W-phase coils 32W is disposed in the outer layer of the slot 311 in which a corresponding one of the first coils of the W-phase coils 32W is disposed. Another part of each second coil of the W-phase coils 32W is disposed in the outer layer of the slot 311 in which a corresponding one of the third coils of the W-phase coils 32W is disposed.

A part of each third coil of the W-phase coils 32W is disposed in the inner layer of the slot 311 in which a corresponding one of the second coils of the W-phase coils 32W is disposed. Another part of each third coil of the W-phase coils 32W is disposed in the outer layer of the slot 311 in which a corresponding one of the first coils of the U-phase coils 32U is disposed. Thus, another part of each third coil of the W-phase coils 32W is disposed outside the first coil of the U-phase coils 32U in the radial direction in the slot 311.

### Advantages of Fourth Embodiment

The electric motor 1 according to the fourth embodiment has the advantages described in the first through third embodiments.

### Fifth Embodiment

A compressor 300 according to a fifth embodiment will be described.

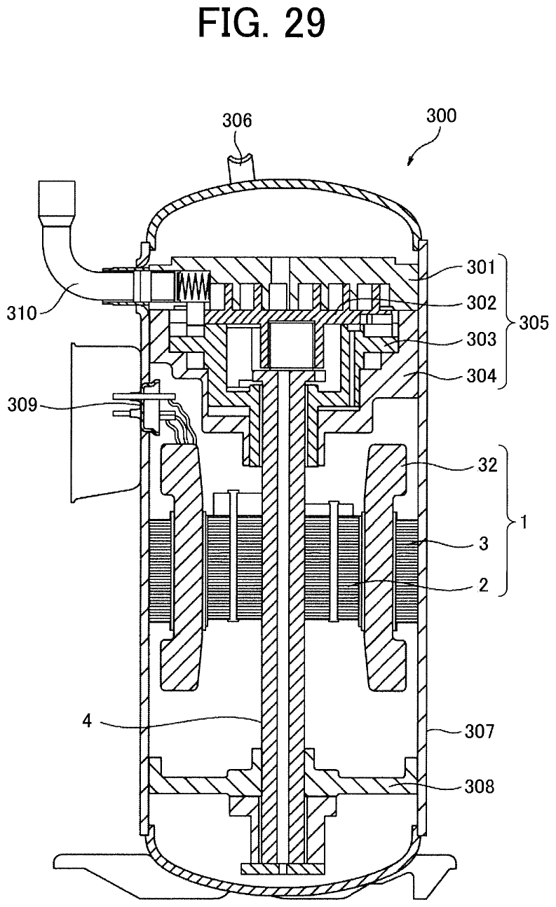

FIG. 29 is a cross-sectional view schematically illustrating a structure of the compressor 300.

The compressor 300 includes an electric motor 1 as an electric element, a closed container 307 as a housing, and a compression mechanism 305 as a compression element (also referred to as a compression device). In this embodiment, the compressor 300 is a scroll compressor. The compressor 300 is not limited to the scroll compressor. The compressor 300 may be a compressor except for the scroll compressor, such as a rotary compressor.

The electric motor 1 in the compressor 300 is the electric motor 1 described in the first embodiment. The electric motor 1 drives the compression mechanism 305.

The compressor 300 includes a subframe 308 supporting a lower end (i.e., an end opposite to the compression mechanism 305) of a shaft 4.

The compression mechanism 305 is disposed inside the closed container 307. The compressor mechanism 305 includes a fixed scroll 301 having a spiral portion, a swing scroll 302 having a spiral portion forming a compression chamber between the spiral portion of the swing scroll 302 and the spiral portion of the fixed scroll 301, a compliance frame 303 holding an upper end of the shaft 4, and a guide frame 304 fixed to the closed container 307 and holding the compliance frame 303.

A suction pipe 310 penetrating the closed container 307 is press fitted in the fixed scroll 301. The closed container 307 is provided with a discharge pipe 306 that discharges a high-pressure refrigerant gas discharged from the fixed scroll 301, to the outside. The discharge pipe 306 communicates with an opening disposed between the compressor mechanism 305 of the closed container 307 and the electric motor 1.

The electric motor 1 is fixed to the closed container 307 by fitting the stator 3 in the closed container 307. The configuration of the electric motor 1 has been described above. To the closed container 307, a glass terminal 309 for supplying electric power to the electric motor 1 is fixed by welding.

When the electric motor 1 rotates, this rotation is transferred to the swing scroll 302, and the swing scroll 302 swings. When the swing scroll 302 swings, the volume of the compression chamber formed by the spiral portion of the swing scroll 302 and the spiral portion of the fixed scroll 301 changes. Then, a refrigerant gas is sucked through the suction pipe 310, compressed, and then discharged through the discharge pipe 306.

The compressor 300 includes the electric motor 1 described in the first through fourth embodiments, and thus, has advantages described in the first embodiment.

In addition, since the compressor 300 includes the electric motor 1 described in the first through fourth embodiments, performance of the compressor 300 can be improved.

### Sixth Embodiment

A refrigeration air conditioning apparatus 7 serving as an air conditioner and including the compressor 300 according to the fifth embodiment will be described.

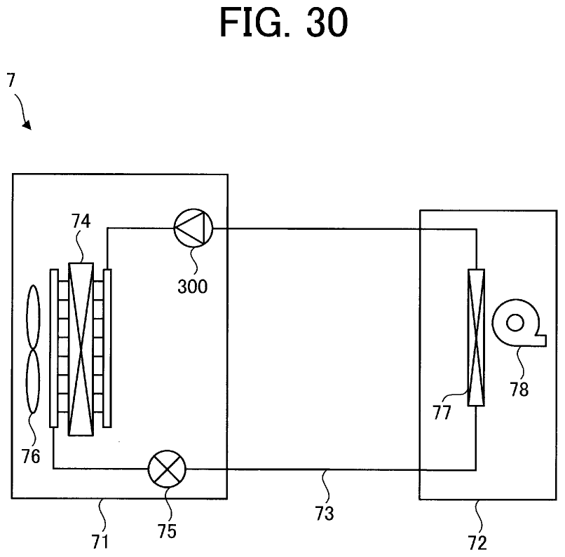

FIG. 30 is a diagram schematically illustrating a configuration of the refrigerating air conditioning apparatus 7 according to a sixth embodiment.

The refrigeration air conditioning apparatus 7 is capable of performing cooling and heating operations, for example. The refrigerant circuit diagram illustrated in FIG. 30 is an example of a refrigerant circuit diagram of an air conditioner capable of performing a cooling operation.

The refrigeration air conditioning apparatus 7 according to the sixth embodiment includes an outdoor unit 71, an indoor unit 72, and a refrigerant pipe 73 connecting the outdoor unit 71 and the indoor unit 72.

The outdoor unit 71 includes a compressor 300, a condenser 74 as a heat exchanger, a throttling device 75, and an outdoor air blower 76 (first air blower). The condenser 74 condenses a refrigerant compressed by the compressor 300. The throttling device 75 decompresses the refrigerant condensed by the condenser 74 to thereby adjust a flow rate of the refrigerant. The throttling device 75 will be also referred to as a decompression device.

The indoor unit 72 includes an evaporator 77 as a heat exchanger, and an indoor air blower 78 (second air blower). The evaporator 77 evaporates the refrigerant decompressed by the throttling device 75 to thereby cool indoor air.

A basic operation of a cooling operation in the refrigeration air conditioning apparatus 7 will now be described. In the cooling operation, a refrigerant is compressed by the compressor 300 and the compressed refrigerant flows into the condenser 74. The condenser 74 condenses the refrigerant, and the condensed refrigerant flows into the throttling device 75. The throttling device 75 decompresses the refrigerant, and the decompressed refrigerant flows into the evaporator 77. In the evaporator 77, the refrigerant evaporates, and the refrigerant (specifically a refrigerant gas) flows into the compressor 300 of the outdoor unit 71 again. When the air is sent to the condenser 74 by the outdoor air blower 76, heat moves between the refrigerant and the air. Similarly, when the air is sent to the evaporator 77 by the indoor air blower 78, heat moves between the refrigerant and the air.

The configuration and operation of the refrigeration air conditioning apparatus 7 described above are examples, and the present invention is not limited to the examples described above.

The refrigeration air conditioning apparatus 7 according to the sixth embodiment includes the electric motor 1 described in the first through fourth embodiments, and thus, the refrigeration air conditioning apparatus 7 has advantages corresponding to one of the first through fourth embodiments.

In addition, since the refrigeration air conditioning apparatus 7 according to the sixth embodiment includes the compressor 300 according to the fifth embodiment, performance of the refrigeration air conditioning apparatus 7 can be improved.

Features of the embodiments described above and features of variations thereof can be combined.

1. An electric motor comprising:
a stator including a stator core including 6×n (n is an integer equal to or larger than 1) slots and three-phase coils attached to the stator core by distributed winding, the three-phase coils forming 2×n magnetic poles;
a rotor including a permanent magnet and disposed inside the stator; and
a connection switching unit to switch a connection state of the three-phase coils between a first connection state and a second connection state that is different from the first connection state, wherein
the three-phase coils include 2×n U-phase coils, 2×n V-phase coils, and 2×n W-phase coils in a coil end of the three-phase coils, and
each coil of the three-phase coils is disposed in two slots of the 6×n slots across one slot on one end side of the stator core.

2. An electric motor comprising:
a stator including a stator core including 9×n (n is an integer equal to or larger than 1) slots and three-phase coils attached to the stator core by distributed winding, the three-phase coils forming 4×n magnetic poles;
a rotor including a permanent magnet and disposed inside the stator; and
a connection switching unit to switch a connection state of the three-phase coils between a first connection state and a second connection state that is different from the first connection state, wherein
the three-phase coils include 3×n U-phase coils, 3×n V-phase coils, and 3×n W-phase coils in a coil end of the three-phase coils,
each coil of the three-phase coils is disposed in two slots of the 9×n slots across one slot on one end side of the stator core, and
the number of slots per pole per phase is 3.

3. The electric motor according to claim 2, wherein
each of the 3×n U-phase coils, the 3×n V-phase coils, and the 3×n W-phase coils includes n sets of coil groups, each of the n sets of coil groups being a set of first through third coils,
each of the 9×n slots includes an inner layer in which one of the three-phase coils is disposed and an outer layer in which one of the three-phase coils is disposed, the outer layer being located outside the inner layer in a radial direction,
the first coil is disposed in the inner layer,
the second coil is disposed in the outer layer,
a part of each third coil of the U-phase coils is disposed in the inner layer of the slot in which a corresponding one of the second coils of the U-phase coils is disposed,
another part of each third coil of the U-phase coils is disposed in the outer layer of the slot in which a corresponding one of the first coils of the V-phase coils is disposed,
a part of each third coil of the V-phase coils is disposed in the inner layer of the slot in which a corresponding one of the second coils of the V-phase coils is disposed,
another part of each third coil of the V-phase coils is disposed in the outer layer of the slot in which a corresponding one of the first coils of the W-phase coils is disposed,
a part of each third coil of the W-phase coils is disposed in the inner layer of the slot in which a corresponding one of the second coils of the W-phase coils is disposed, and
another part of each third coil of the W-phase coils is disposed in the outer layer of the slot in which a corresponding one of the first coils of the U-phase coils is disposed.

4. The electric motor according to claim 1, wherein
while the connection state of the three-phase coils is the first connection state, the rotor rotates at a rotation speed corresponding to an intermediate condition of an air conditioner, and
while the connection state of the three-phase coils is the second connection state, the rotor rotates at a rotation speed corresponding to a rated condition of the air conditioner.

5. The electric motor according to claim 1, wherein
while the rotor rotates at a rotation speed corresponding to an intermediate condition of an air conditioner, the connection state of the three-phase coils is the first connection state, and
while the rotor rotates at a rotation speed corresponding to a rated condition of the air conditioner, the connection state of the three-phase coils is the second connection state.

6. The electric motor according to claim 1, wherein the first connection state is Y connection, and the second connection state is delta connection.

7. The electric motor according to claim 6, wherein in a case where a rotation speed of the electric motor reaches a rotation speed at which motor efficiency of the electric motor in the Y connection coincides with motor efficiency of the electric motor in the delta connection, the connection switching unit sets the connection state of the three-phase coils at the delta connection.

8. The electric motor according to claim 1, wherein the first connection state is series connection in which coils of each phase in the three-phase coils are connected in series, and the second connection state is parallel connection in which coils of each phase in the three-phase coils are connected in parallel.

9. The electric motor according to claim 1, wherein the first connection state is series connection in which coils of each phase in the three-phase coils are connected in series, and the second connection state is m parallel connection in which m (m is an integer equal to or larger than 2) coils are connected in parallel in each phase of the three-phase coils.

10. The electric motor according to claim 9, wherein the electric motor satisfies (N2/N1)>m (m is an integer equal to or larger than 2), where N1 is a rotation speed corresponding to an intermediate condition of an air conditioner, and N2 is a rotation speed corresponding to a rated condition of the air conditioner.

11. A driving device comprising:
the electric motor according to claim 1; and
a control device to control the connection switching unit.

12. A compressor comprising:
a closed container;
a compression device disposed in the closed container; and
the electric motor according to claim 1 to drive the compression device.

13. An air conditioner comprising:
the compressor according to claim 12; and
a heat exchanger.

14. The electric motor according to claim 2, wherein
while the connection state of the three-phase coils is the first connection state, the rotor rotates at a rotation speed corresponding to an intermediate condition of an air conditioner, and
while the connection state of the three-phase coils is the second connection state, the rotor rotates at a rotation speed corresponding to a rated condition of the air conditioner.

15. The electric motor according to claim 2, wherein
while the rotor rotates at a rotation speed corresponding to an intermediate condition of an air conditioner, the connection state of the three-phase coils is the first connection state, and
while the rotor rotates at a rotation speed corresponding to a rated condition of the air conditioner, the connection state of the three-phase coils is the second connection state.

16. The electric motor according to claim 2, wherein the first connection state is Y connection, and the second connection state is delta connection.

17. The electric motor according to claim 2, wherein the first connection state is series connection in which coils of each phase in the three-phase coils are connected in series, and the second connection state is parallel connection in which coils of each phase in the three-phase coils are connected in parallel.

18. The electric motor according to claim 2, wherein the first connection state is series connection in which coils of each phase in the three-phase coils are connected in series, and the second connection state is m parallel connection in which m (m is an integer equal to or larger than 2) coils are connected in parallel in each phase of the three-phase coils.

19. A driving device comprising:
the electric motor according to claim 2; and
a control device to control the connection switching unit.

20. A compressor comprising:
a closed container;
a compression device disposed in the closed container; and
the electric motor according to claim 2 to drive the compression device.
